(19) United States
(12) Patent Application Publication
(10) Pub. No.: US 2023/0148645 A1
(43) Pub. Date: May 18, 2023

(54) THERAPEUTIC COMPOSITION

(71) Applicant: Prabhakaran PANDURANGAN, Bangalore (IN)

(72) Inventor: Prabhakaran PANDURANGAN, Bangalore (IN)

(21) Appl. No.: 17/917,913

(22) PCT Filed: Feb. 10, 2021
(86) PCT No.: PCT/IB2021/051072

§ 371 Date: Oct. 7, 2022

(30) Foreign Application Priority Data
Apr. 9, 2020 (IN) 202041015667

(51) Int. Cl. A23L 33/135; A23L 27/30; A23L 33/185; A23L 33/195

(52) U.S. Cl. CPC A23L 33/135; A23L 27/33; A23L 33/185; A23L 33/195

(57) ABSTRACT

The present invention relates to an enzobiotic therapeutic combination, process for their preparation, enzobiotic therapeutical compositions containing them and their use as a therapeutic supplement or a nutritional supplement or a food supplement in renal diseases and disorders. The said combination comprising a therapeutically effective amount of: a) a synbiotic comprising at least one prebiotic and at least one probiotic and b) at least one proteolytic enzyme. The present invention further relates to kits and methods of using them. The enzobiotic combination and the enzobiotic composition comprising the said combination is particularly useful as a therapeutic supplement or a nutritional supplement or a food supplement to prevent generation of protein bound uremic toxins generated by undigested protein, to postpone dialysis and improve quality of life in subjects suffering from chronic kidney disease and end stage renal disease.

### TECHNICAL FIELD OF THE INVENTION

The present invention relates to an enzobiotic therapeutic combination, process for their preparation, enzobiotic therapeutical compositions containing them and their use as a therapeutic supplement or a nutritional supplement or a food supplement in renal diseases and disorders. The present invention further relates to kits and methods of using them. The enzobiotic combination and the enzobiotic composition comprising the said combination is particularly useful as a therapeutic supplement or a nutritional supplement or a food supplement to prevent formation of protein bound uremic toxins generated by undigested protein, to postpone dialysis and improve quality of life in subjects suffering from chronic kidney disease and end stage renal disease.

### BRIEF DESCRIPTION OF THE INVENTION

Chronic kidney disease (hereinafter also referred to as “CKD”) is a condition characterized by a gradual loss of kidney function over a period of months to years. Chronic kidney disease (CKD) represents a major public health issue and an increasing numbers of patients are affected by chronic kidney disease worldwide. It is characterised by nutritional disorders and systemic inflammation, which is accompanied by an increased catabolism, increasing morbidity and mortality. When a CKD patient needs renal replacement therapy, the condition is called end-stage renal disease (hereinafter also referred to as “ESRD”). It is generally associated with old age, diabetes, hypertension, obesity, and cardiovascular disease.

The presence of malnutrition in CKD is well known in the art. Protein-energy wasting (hereinafter referred to as PEW) is one of the strongest predictors of mortality in patients with CKD. International Society of Renal Nutrition and Metabolism (ISRNM) in the year 2007 defined PEW as a state of nutritional and metabolic derangements in patients with CKD, characterized by simultaneous loss of systematic body protein and energy stores, leading ultimately to loss of muscle and fat mass and cachexia. Malnutrition is often considered synonymous with PEW. The common factor binding the two entities is inadequate dietary nutrition intake; but unlike PEW, the adaptive metabolic response is preserved in malnutrition.

The intestinal microbiota has emerged as an important trigger for progression and complications of CKD. Prolonged retention of undigested protein in the intestines triggers immune response causing discomfort and inflammation in the gut and formation of uremic toxins like p-cresol (also referred to as “para-cresol”) sulfate and indoxyl sulfate, which play an important role in the genesis of cardiovascular complications and progression of renal damage in CKD.

CKD coupled with cardiovascular disease (hereinafter referred to as “CVD”) is emerging as a major public health problem. CVD has been considered as one of the most common chronic conditions attributable to the burden of disease worldwide (The Global Burden of Disease: 2004 Update, WHO Press, Geneva, Switzerland, 2004). CKD is characterised by a gradual reduction in elimination of uremic toxins in the body. The uremic toxin retention during CKD progression contributes to several systemic symptoms, called the uremic syndrome or uremia (Vanholder R. et al., Kidney Int. 2003; 63 (suppl. 84):56-S10). Moreover, CVD is highly prevalent in CKD, such that CKD patients are far more likely to experience cardiovascular (CV) mortality than progression to end-stage renal failure (D. E. Wiener et al., J. Am. Soc. Nephrol.; 2004; 15(5):1307-1315). Therefore, treatment to reduce both CKD progression and CV mortality is urgently required in such conditions (Megan Rossi et al., Int. J. Nephrol.; 2012; 673631:1-20). Recent studies suggest that two protein-bound toxins, p-cresyl sulphate and indoxyl sulphate may be the risk factors for the high CV mortality rates observed in the CKD population (B. K. I. Meijers et al., Clin. J. Am. Soc. Nephrol.; 2009; 4:1932-38; Szu-Chun Hung et al., J. Am. Heart Assoc. 2017; 6 (2):e005022:1-8).

Uremic toxins can be divided into three categories depending on the biochemical and physical properties. The first group comprises water-soluble non-protein binding, low-molecular weight compounds, such as urea and creatinine. The second group comprises larger or medium molecular weight compounds such as 2-microglobulin. The third group contains protein binding, low molecular weight compounds such as indoxyl sulphate, p-cresol or p-cresyl sulphate. Among the uremic toxins, the protein-binding compounds such as indoxyl sulphate are difficult to remove via classical dialysis because of their strong protein-binding capabilities (Wen-Chuh Liu et al., Toxins; 2018:10(367):1-22). The increase in p-cresol and indoxyl sulphate toxin production in CKD patients, coupled with inadequate renal clearance, results in high serum levels (C. J. Lin et al., J. Clin. Lab. Anal. 2011; 25(3):191-197).

The CKD-induced changes in the composition and function of the gut microbiota represent a dysbiotic state that has adverse consequences. For example, increased generation of toxic solutes (e.g., indoxyl sulfate, p-cresol sulphate, and trimethylamine-N-oxide) and diminished production of beneficial micronutrients may contribute to systemic inflammation, CKD progression, and cardiovascular complications (Niwa T, Ther. Apher. Dial. 2011; 15(2):120-124; Aronov P A, et al., J Am Soc Nephrol 2011; 22:1769-1776). Increased formation of these toxic metabolites (like indoxyl sulphate, p-cresol sulphate and trimethyl N-oxide) disruption of the intestinal epithelial barrier, changes in the gut milieu, and the resulting microbial dysbiosis play a major role in the pathogenesis of systemic inflammation, a likely important contributor to morbidity and mortality in the CKD population (Vaziri N D et al., Nephrol. Dial. Transplant; 2016:31:736-747).

It has been seen that infectious diseases are the second most common causes of morbidity and mortality (after CVD) in patients with CKD, contributing to 30-36% of deaths among patients on dialysis. Various factors affect immunity in these patients, such as uremic toxins, malnutrition, chronic inflammation and immunosuppressive medications, which are further complicated by renal replacement therapies. Many studies have shown that both native and acquired immune systems are impaired in such patients.

More recently, statistics reveal higher incidences of death in COVID-19 patients are predominantly contributed by CKD patients. CKD patients are more prone to infections and past data also reveals increase in mortality rates due to pre-existing kidney disease exposed to severe acute respiratory syndrome coronavirus 2 (hereinafter referred to as SARS-CoV-2; the World Health Organisation named this coronavirus disease as COVID-19) infection.

The approaches that have been tested in humans and animals with CKD: (1) probiotic therapy with administration of live microbial species, (2) oral adsorbents to limit absorption of the microbial derived toxins, (3) prebiotics to restore symbiotic and suppress dysbiotic microbes, and (4) a combination of prebiotics and probiotics (synbiotic) (Vaziri N. D., Clin. J. Am. Soc. Nephrol. 2016; 11:199-201).

United States U.S. Pat. No. 5,716,615 discloses a pharmaceutical composition containing several different bacteria including Streptococcus thermophilus, Lactobacillus plantarum, Lactobacillus casei and Bifidobacteria, the said composition used for the treatment of a gastrointestinal disorder and hypercholesteremia or modulating a hosts immune response. PCT publication number WO 2007140622A1 discloses probiotic composition comprising living bacteria selected from the group of propionibacteria, lactic acid bacteria (such as lactobacilli), bifidobacteria and streptococcus, said composition used as a food supplement, useful in the restoration of gastrointestinal flora and in the treatment of gastrointestinal disorders. U.S. Pat. No. 8,257,693 and related U.S. Pat. No. 8,481,025 disclose a composition comprising Lactobacillus acidophilus, Streptococcus thermophilus, Bifidobacterium longum, and psyllium husks, wherein said composition is enterically coated, reduces nitrogenous wastes and used for maintaining healthy kidney function. U.S. Pat. No. 9,237,763 B2 relates to a synbiotic composition comprising a prebiotic carbohydrate and a probiotic spore-forming Bacillus bacteria selected from the group consisting of Bacillus subtilis, Bacillus licheniformis, Bacillus pumilis and mixtures thereof, useful as a nutritional food or as an animal feed. PCT publication number WO 2018125735A1 discloses a delayed release composition comprising Lactobacillus acidophilus, Streptococcus thermophilus, Bifidobacterium longum, xylooligosaccharide and inulin for removing nitrogenous wastes and maintaining kidney function. PCT publication number WO2019203827A1 relates to a composition comprising at least two probiotic components which include a Lactobacillus acidophilus bacterium and a Lactobacillus rhamnosus bacterium and a curcuminoid that includes curcumin, for reducing uric acid levels in blood and urine and for treating hyperuricemia or gout. Our copending Indian patent application number 202041004499 relates to a therapeutic composition comprising the proteolyse enzyme comprising B. subtilis for use in the treatment of renal diseases and disorders, wherein the renal disease or a disorder is CKD.

There is a continuing need for safe and efficacious therapeutic agents for CKD and ESRD, the need to improve survival in such patients, also improve survival of CKD patients with CVD and improve recovery of CKD patients in subjects suffering from SARS-CoV-2 or COVID-19 infection.

The inventors of the present application have surprisingly arrived at an enzobiotic therapeutic combination which can fulfill the widely recognized need by providing a safe and an effective therapeutic supplement or a nutritional supplement or a food supplement in the treatment of renal diseases or disorders, in particular CKD and ESRD. The inventors have further found that the enzobiotic combination and an enzobiotic composition comprising the said combination are effective in reducing protein-bound uremic toxins in patients with CKD in addition to improving cardiac performance, prevent renal damage, improve their survival and deliver other therapeutic benefits.

### Objects of the Invention

It is an object of the present invention to provide an enzobiotic therapeutic combination comprising a therapeutically effective amount of: (i) a synbiotic comprising at least one probiotic and at least one prebiotic; and (ii) at least one proteolytic enzyme.

It is another object of the present invention to provide an enzobiotic therapeutic combination comprising a therapeutically effective amount of:
(i) a synbiotic comprising at least one probiotic and at least one prebiotic; and (ii) a proteolytic enzyme, wherein, said combination is capable of reducing the concentration of protein bound uremic toxins, p-cresol (para-cresol) and indoxyl sulphate; and wherein, said combination when administered to a subject in need thereof provides nephroprotective effect.

It is another object of the invention to provide an enzobiotic therapeutic combination comprising the said therapeutic combination and at least one further therapeutic agent.

It is another object of the present invention to provide an enzobiotic therapeutic composition comprising the said therapeutic combination; and at least one therapeutically acceptable carrier.

It is another object of the present invention to provide an enzobiotic therapeutic composition comprising the said therapeutic combination, at least one further therapeutic agent and at least one therapeutically acceptable carrier.

It is a yet another object of the present invention to provide an enzobiotic therapeutic composition, wherein, the said composition is capable of reducing the concentration of protein bound uremic toxins, p-cresol and indoxyl sulphate; and wherein, the said composition when administered to a subject in need thereof provides nephroprotective effect.

It is a yet another object of the present invention to provide an enzobiotic therapeutic combination comprising a therapeutically effective amount of: (i) a synbiotic comprising at least one probiotic and at least one prebiotic; and (ii) at least one proteolytic enzyme for use in the treatment or prophylaxis of renal diseases or disorders, particularly chronic kidney disease.

It is a further object of the present invention to provide an enzobiotic kit comprising (i) a therapeutically effective amount of: (i) a synbiotic comprising at least one probiotic and at least one prebiotic; and (ii) at least one proteolytic enzyme, wherein the synbiotic when administered in combination with the proteolytic enzyme is capable of reducing the concentration of protein bound uremic toxins, p-cresol and indoxyl sulphate and providing nephroprotective effect in a subject more than when administered alone.

It is yet further object of the present invention to provide a method for treatment of renal diseases or disorders, in a subject, comprising administering to a subject in need thereof a therapeutically effective amount of said therapeutical combination, wherein said combination is capable of reducing the concentration of protein bound uremic toxins, p-cresol and indoxyl sulphate; and wherein, the said combination when administered to a subject in need thereof provides nephroprotective effect.

### SUMMARY OF THE INVENTION

The present invention provides an enzobiotic therapeutic combination comprising a therapeutically effective amount of: (i) a synbiotic comprising at least one probiotic and at least one prebiotic; and (ii) at least one proteolytic enzyme.

In another aspect, the present invention provides an enzobiotic therapeutic combination comprising a therapeutically effective amount of:
(i) a synbiotic comprising at least one probiotic and at least one prebiotic; and (ii) at least one proteolytic enzyme,
wherein, said combination is capable of reducing the concentration of protein bound uremic toxins, p-cresol (para cresol) by 20 to 30% and indoxyl sulphate by 500 to 1500 μg/ml; and wherein, said combination when administered to a subject in need thereof provides nephroprotective effect.

In a further aspect, the present invention provides an enzobiotic therapeutic combination, wherein the probiotic is at least one of the said Lactobacillus strains selected from the group consisting of L. acidophilus, L. brevis, L. bulgaricus, L. casei, L. fermentum, L. helviticus, L. plantarum, L. leichmannii, L. salivarius and L. cellobiosus or combinations thereof.

In a yet further aspect, the present invention provides an enzobiotic therapeutic combination, wherein the probiotic is at least one of the said Lactobacillus strains selected from Lactobacillus acidophilus and Lactobacillus plantarum.

In a yet further aspect, the present invention provides an enzobiotic therapeutic combination, wherein the probiotic is a Lactobacillus strain, preferably Lactobacillus acidophilus ATCC 4356 strain.

In a further aspect, the present invention provides an enzobiotic therapeutic combination, wherein the probiotic is at least one of the said Bifidobacterium strains selected from the group consisting of B. bifidum, B. longum and B. infantis or combinations thereof.

In a yet further aspect, the present invention provides an enzobiotic therapeutic combination, wherein the probiotic is a Bifidobacterium strain, preferably Bifidobacterium longum ATCC 15707 strain.

In a further aspect, the present invention provides an enzobiotic therapeutic combination, wherein the probiotic is at least one of the said Streptococcus strains selected from the group consisting of S. thermophilus, S. diacetilactis, S. cremoris, S. durans and S. faecalis or combinations thereof.

In a yet further aspect, the present invention provides an enzobiotic therapeutic combination, wherein the probiotic is a Streptococcus strain, preferably Streptococcus thermophilus ATCC 19258 strain.

In a yet further aspect, the present invention provides an enzobiotic therapeutic combination, wherein the probiotic is at least one of the bacterial strains selected from Lactobacillus acidophilus ATCC 4356 strain, Bifidobacterium longum ATCC 15707 strain and Streptococcus thermophilus ATCC 19258 strain or combinations thereof.

In another aspect, the present invention provides an enzobiotic therapeutic combination, wherein the prebiotic is an oligosaccharide selected from the group consisting of fructooligosaccharide, inulin, pectic polysaccharide, a mannan, a beta-glucan, a pentosan, an arabinan, a galactan or combinations thereof.

In a further aspect, the present invention provides an enzobiotic therapeutic combination, wherein the prebiotic is an oligosaccharide, preferably fructooligosaccharide.

In another aspect, the present invention provides an enzobiotic therapeutic combination, wherein the proteolytic enzyme is selected from the group consisting of pepsin, trypsin, chymotrypsin, an enzyme obtained from a fungal strain or a bacterial strain and an enzyme obtained from fruits of Ananas comosus.

In a further aspect, the present invention provides an enzobiotic therapeutic combination, wherein the proteolytic enzyme is obtained from a bacterial strain, preferably Bacillus subtilis ATCC 11774 in combination with bromelain extract obtained from fruits of Ananas comosus.

In another aspect, the present invention provides an enzobiotic therapeutic combination, wherein the (i) said synbiotic comprises a) a probiotic selected from at least one of the bacterial strains selected from Lactobacillus acidophilus ATCC 4356 strain, Bifidobacterium longum ATCC 15707 strain and Streptococcus thermophilus ATCC 19258 strain or combinations thereof; b) a prebiotic, preferably a fructooligosaccharide; and (ii) a proteolytic enzyme obtained from a bacterial strain, preferably Bacillus subtilis ATCC 11774 strain comprising bacterial protease whole cell in combination with bromelain extract obtained from the fruits of Ananas comosus.

In a further aspect, the present invention provides an enzobiotic therapeutic combination, wherein the combination comprises (i) a synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain; b) 15 to 25 wt % of fructooligosaccharide; and (ii) 15 to 45 wt % of a proteolytic enzyme obtained from a bacterial strain, preferably Bacillus subtilis ATCC 11774 strain comprising bacterial protease whole cell in combination with bromelain extract obtained from the fruits of Ananas comosus.

In a yet further aspect, the present invention provides an enzobiotic therapeutic combination, wherein the combination comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) 100 to 500 mg of fructooligosaccharide; and (ii) 50 to 200 mg of Bacillus subtilis ATCC 11774 strain comprising bacterial protease whole cell in combination with bromelain extract obtained from fruits of Ananas comosus having a protease activity of 25,000 to 70,000 HUT.

In another aspect, the present invention provides an enzobiotic therapeutic combination, wherein the said combination comprises at least one further therapeutical agent.

In another aspect, the present invention provides an enzobiotic therapeutic composition comprising the said therapeutic combination; and at least one therapeutically acceptable carrier.

In a yet another aspect, the present invention provides an enzobiotic therapeutic composition comprising the said therapeutic combination; and at least one further therapeutical agent and at least one therapeutically acceptable carrier.

In a yet further aspect, the present invention provides an enzobiotic therapeutic composition, wherein, the said composition is capable of reducing the concentration of protein bound uremic toxins, p-cresol and indoxyl sulphate; and wherein, the said composition when administered to a subject in need thereof provides nephroprotective effect.

In a yet further aspect, the present invention provides an enzobiotic therapeutic composition, wherein, the further therapeutic agent is selected from at least one of a probiotic, a prebiotic, a synbiotic comprising at least one probiotic and at least one prebiotic, a micronutrient selected from a vitamin and a mineral.

In a yet further aspect, the present invention provides an enzobiotic therapeutic composition, wherein, the further therapeutic agent is selected from a micronutrient selected from a vitamin and a mineral.

In a still further aspect, the present invention provides an enzobiotic therapeutic composition, wherein the therapeutically acceptable carrier is selected from an anti caking agent, a filler, a sweetening agent, a flavouring agent and other optional additives.

In a still further aspect, the present invention provides an enzobiotic therapeutic composition, wherein the therapeutically acceptable carrier is selected from an anticaking agent selected from the group consisting of starch, modified starches and magnesium stearate, a filler selected from the group consisting of microcrystalline cellulose, maltodextrin, sucralose, talc and starch, a sweetening agent selected from the group consisting of maltodextrin, sucralose, sucrose or saccharin, a flavouring agent, preferably orange flavour and other optional additives.

In another aspect, the present invention provides an enzobiotic therapeutic composition, wherein the composition is formulated in the form of an oral tablet, oral capsule, powder, sachet, liquid syrup, health drink and nutritional bar.

In another aspect, the present invention provides an enzobiotic kit, wherein, (i) a synbiotic comprising at least one probiotic and at least one prebiotic; and (ii) at least one proteolytic enzyme, wherein the synbiotic administered in combination with the proteolytic enzyme is capable of reducing protein bound uremic toxins, p-cresol and indoxyl sulphate and providing nephroprotective effect in a subject more than when administered alone.

In another aspect, the present invention provides a method of reducing protein bound uremic toxins, in a subject, comprising administering to a subject in need thereof, a therapeutically effective amount of an enzobiotic therapeutical combination, wherein said combination comprises a therapeutically effective amount of: (i) a synbiotic comprising at least one probiotic and at least one prebiotic; and (ii) at least one proteolytic enzyme.

In another aspect, the present invention provides a method for treatment of renal diseases or disorders, in a subject, comprising administering to a subject in need thereof, a therapeutically effective amount of an enzobiotic therapeutical combination comprising a therapeutically effective amount of: (i) a synbiotic comprising at least one probiotic and at least one prebiotic; and (ii) at least one proteolytic enzyme, wherein said combination is capable of reducing protein bound uremic toxins, p-cresol and indoxyl sulphate; and wherein, said combination when administered to a subject in need thereof provides nephroprotective effect.

In a yet another aspect, the present invention provides an enzobiotic therapeutic combination comprising a therapeutically effective amount of: (i) a synbiotic comprising at least one probiotic and at least one prebiotic; and (ii) at least one proteolytic enzyme for use in the treatment or prophylaxis of renal diseases or disorders.

In a yet further aspect, the present invention provides an enzobiotic therapeutic combination comprising a therapeutically effective amount of: (i) a synbiotic comprising at least one probiotic and at least one prebiotic; and (ii) at least one proteolytic enzyme for use in the treatment or prophylaxis of renal diseases or disorders, wherein the renal disease or disorder is a stage 1, stage 2, stage 3, stage 4 or stage 5 chronic kidney disease (CKD), end stage renal disease (ESRD), chronic kidney disease in cardiovascular patients and chronic kidney disease in subjects suffering from severe acute respiratory syndrome coronavirus 2 (SARS-CoV-2 or COVID-19) infection.

In a still further aspect, the present invention relates to the use of the enzobiotic therapeutic combination in the manufacture of a therapeutic supplement or a nutritional supplement or a food supplement for treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

In a still further aspect, the present invention relates to the use of the enzobiotic therapeutic composition comprising said enzobiotic combination, in the manufacture of a therapeutic supplement, nutritional supplement or a food supplement for treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

These and other objectives and advantages of the present invention will be apparent to those skilled in the art from the following description and drawings.

### BRIEF DESCRIPTION OF THE DRAWINGS

FIG. 1a depicts the histopathological examination of Hemotoxylin and Eosin stained kidney of male animal rats of treatment group 1 (Control), wherein no gentamycin or no product was administered to the rats and only dosed with water.

FIG. 1b depicts the histopathological examination of Hemotoxylin and Eosin stained kidney of female animal rats of treatment group 1 (Control), wherein no gentamycin or no product was administered to the rats and only dosed with water.

FIG. 2a depicts the histopathological examination of Hemotoxylin and Eosin stained kidney of male animal rats of treatment group 2 (Positive Control), wherein only Enzobiotic combination C of the present invention at a dose of 1075 mg/day in three divided doses was administered.

FIG. 2b depicts the histopathological examination of Hemotoxylin and Eosin stained kidney of female animal rats of treatment group 2 (Positive Control), wherein only Enzobiotic combination C of the present invention at a dose of 1075 mg/day in three divided doses was administered. FIG. 3a depicts the histopathological examination of Hemotoxylin and Eosin stained kidney of male animal rats of treatment group 3 (Positive Control), wherein only proteolytic enzyme B of the present invention at a dose of 75 mg/day having a protease activity of 26,250 HUT in three divided doses was administered.

FIG. 3b depicts the histopathological examination of Hemotoxylin and Eosin stained kidney of female animal rats of treatment group 3 (Positive Control), wherein only proteolytic enzyme B of the present invention at a dose of 75 mg/day having a protease activity of 26,250 HUT in three divided doses was administered.

FIG. 4a depicts the histopathological examination of Hemotoxylin and Eosin stained kidney of male animal rats of treatment group 4 (Negative Control), wherein only gentamycin at a dose of 150 mg/kg body weight was administered.

FIG. 4b depicts the histopathological examination of Hemotoxylin and Eosin stained kidney of female animal rats of treatment group 4 (Negative Control), wherein only gentamycin at a dose of 150 mg/kg body weight was administered.

FIG. 5a depicts the histopathological examination of Hemotoxylin and Eosin stained kidney of male animal rats of treatment group 5a, wherein gentamycin at a dose of 150 mg/kg body weight followed by Synbiotic A of the present invention at a dose of 1000 mg/day in three divided doses was administered.

FIG. 5b depicts the histopathological examination of Hemotoxylin and Eosin stained kidney of female animal rats of treatment group 5b, wherein gentamycin at a dose of 150 mg/kg body weight followed by Synbiotic A of the present invention at a dose of 1000 mg/day in three divided doses was administered.

FIG. 6a depicts the histopathological examination of Hemotoxylin and Eosin stained kidney of male animal rats of treatment group 6a, wherein gentamycin at a dose of 150 mg/kg body weight followed by proteolytic enzyme B of the present invention at a dose of 75 mg/day having a protease activity of 26,250 HUT in three divided doses was administered.

FIG. 6b depicts the histopathological examination of Hemotoxylin and Eosin stained kidney of female animal rats of treatment group 6b, gentamycin at a dose of 150 mg/kg body weight followed by proteolytic enzyme B of the present invention at a dose of 75 mg/day having a protease activity of 26,250 HUT in three divided doses was administered.

FIG. 7a depicts the histopathological examination of Hemotoxylin and Eosin stained kidney of male animal rats of treatment group 7a, wherein gentamycin at a dose of 150 mg/kg body weight followed by Enzobiotic combination C of the present invention at a dose of 1075 mg/day in three divided doses was administered.

FIG. 7b depicts the histopathological examination of Hemotoxylin and Eosin stained kidney of female animal rats of treatment group 7b, wherein gentamycin at a dose of 150 mg/kg body weight followed by Enzobiotic combination C of the present invention at a dose of 1075 mg/day in three divided doses was administered.

FIG. 8a depicts the histopathological examination of Hemotoxylin and Eosin stained caecum of male animal rats of treatment group 1 (Control), wherein no gentamycin or no product was administered to the rats and only dosed with water.

FIG. 8b depicts the histopathological examination of Hemotoxylin and Eosin stained caecum of female animal rats of treatment group 1 (Control), wherein no gentamycin or no product was administered to the rats and only dosed with water.

FIG. 9a depicts the histopathological examination of Hemotoxylin and Eosin stained caecum of male animal rats of treatment group 2 (Positive Control), wherein only Enzobiotic combination C of the present invention at a dose of 1075 mg/day in three divided doses was administered.

FIG. 9b depicts the histopathological examination of Hemotoxylin and Eosin stained caecum of female animal rats of treatment group 2 (Positive Control), wherein only Enzobiotic combination C of the present invention at a dose of 1075 mg/day in three divided doses was administered.

FIG. 10a depicts the histopathological examination of Hemotoxylin and Eosin stained caecum of male animal rats of treatment group 3 (Positive Control), wherein only proteolytic enzyme B of the present invention at a dose of 75 mg/day having a protease activity of 26,250 HUT in three divided doses was administered.

FIG. 10b depicts the histopathological examination of Hemotoxylin and Eosin stained caecum of female animal rats treatment group 3 (Positive Control), wherein only proteolytic enzyme B of the present invention at a dose of 75 mg/day having a protease activity of 26,250 HUT in three divided doses was administered.

FIG. 11a depicts the histopathological examination of Hemotoxylin and Eosin stained caecum of male animal rats of treatment group 4 (Negative Control), wherein only gentamycin at a dose of 150 mg/kg body weight was administered.

FIG. 11b depicts the histopathological examination of Hemotoxylin and Eosin stained caecum of female animal rats of treatment group 4 (Negative Control), wherein only gentamycin at a dose of 150 mg/kg body weight was administered.

FIG. 12a depicts the histopathological examination of Hemotoxylin and Eosin stained caecum of male animal rats of treatment group 5a, wherein gentamycin at a dose of 150 mg/kg body weight followed by Synbiotic A of the present invention at a dose of 1000 mg/day in three divided doses was administered.

FIG. 12b depicts the histopathological examination of Hemotoxylin and Eosin stained caecum of female animal rats of treatment group 5b, wherein gentamycin at a dose of 150 mg/kg body weight followed by Synbiotic A of the present invention at a dose of 1000 mg/day in three divided doses was administered.

FIG. 13a depicts the histopathological examination of Hemotoxylin and Eosin stained caecum of male animal rats of treatment group 6a, wherein gentamycin at a dose of 150 mg/kg body weight followed by proteolytic enzyme B of the present invention at a dose of 75 mg/day having a protease activity of 26,250 HUT in three divided doses was administered.

FIG. 13b depicts the histopathological examination of Hemotoxylin and Eosin stained caecum of female animal rats of treatment group 6b, wherein gentamycin at a dose of 150 mg/kg body weight followed by proteolytic enzyme B of the present invention at a dose of 75 mg/day having a protease activity of 26,250 HUT in three divided doses was administered.

FIG. 14a depicts the histopathological examination of Hemotoxylin and Eosin stained caecum of female animal rats of treatment group 7a, wherein gentamycin at a dose of 150 mg/kg body weight followed by Enzobiotic combination C of the present invention at a dose of 1075 mg/day in three divided doses was administered.

FIG. 14b depicts the histopathological examination of Hemotoxylin and eosin stained caecum of female animal rats of treatment group 7b, wherein gentamycin at a dose of 150 mg/kg body weight followed by Enzobiotic combination C of the present invention at a dose of 1075 mg/day in three divided doses was administered.

### DETAILED DESCRIPTION OF THE INVENTION

The present invention combines the synergistic properties of a) a synbiotic comprising at least one probiotic and at least one prebiotic component and b) at least one proteolytic enzyme into an enzobiotic combination that effectively reduces the concentration of the nitrogenous wastes in the blood and the urine. The enzobiotic combination of the present invention and the composition comprising this enzobiotic combination further confers the benefit of promoting the growth of gut microbiome. The enzobiotic combination and the composition comprising the said enzobiotic combination can prevent dialysis in chronic kidney disease (hereinafter referred to as CKD) patients by reducing the concentration of uremic toxins, C-reactive protein (hereinafter referred to as CRP), thrombocytopenia. The enzobiotic combination and the composition comprising the said enzobiotic combination is capable of improving cardiac performance, lipid performance and quality of life in CKD patients.

The present invention provides an enzobiotic therapeutic combination comprising: (i) a synbiotic comprising at least one probiotic and at least one prebiotic; and (ii) at least one proteolytic enzyme. The present invention also provides an enzobiotic therapeutic composition comprising the said therapeutic combination and at least one therapeutically acceptable carrier.

### Definitions

Although the present invention will be described with respect to particular embodiments, this description is not to be construed in a limiting sense. It is to be understood that the term “comprising” or “comprise” or “comprises of” or “comprising of” used interchangeably throughout the specification, in the claims and its conjugations are used in its non-limiting sense. Unless the context dictates otherwise, the term “comprise”, “comprising”, “comprises of”, “comprising of” and the like are to be construed in an inclusive manner, that is to say, in the sense of “including, but not limited to”, as opposed to an exclusive or exhaustive manner. For the purposes of the present invention, the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)”, “i”, “ii” etc. and the like in the description and in the claims, are used for distinguishing between similar or different elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

Before describing in detail, exemplary embodiments of the present invention, the definitions important for understanding the present invention are given. As used in this specification and in the appended claims that follow, the singular forms of “a”, “an” and “the” also include the respective plurals unless the context clearly dictates otherwise. Further, as used in the specification herein, the meaning of “in” includes “in” and “on” unless the context clearly dictates otherwise. It should be further noted that the term “or” is generally employed in its sense including “and/or” unless the context clearly dictates otherwise. Unless noted otherwise, all percentages in the specification pertain to weight percent, wherever applicable. As used herein, all numerical ranges herein should be construed to include all integer, whole number or fractions, within the range.

Unless otherwise indicated, the following definitions are set forth to illustrate and define the meaning and scope of the various terms used to describe the invention herein and the appended claims. These definitions should not be interpreted in the literal sense as their complete scope do not pertain to general definitions and their contextual scope are relevant only for this application.

The term “probiotic” or “probiotic component” as used herein, is defined as live microorganisms that, when administered in adequate amounts, confer health benefits to the host, according to World Heath Organisation (WHO) guidelines. Within the context of the present invention and as used herein, the term “probiotic” is defined as a mono culture or a mixed culture of live or freeze-dried microorganisms, spores, fractions or metabolic products, microbial cell preparations or components of microbial cells thereof, which, when administered to a host, confer a beneficial therapeutic, nutritional, dietary or prophylactic effect on the host. The probiotic also improves the intestinal microbial balance and may also activate the immune function of the host. The probiotics that may be employed in the present invention include, but not limited to, Aerococcus, Aspergillus, Bacillus, Bacteroides, Bifidobacterium, Candida, Clostridium, Debaromyces, Enterococcus, Fusobacterium, Lactobacillus, Lactococcus, Melissococcus, Micrococcus, Mucor, Oenococcus, Pediococcus, Penicillium, Peptostreptococcus, Propionibacterium, Rhizopus, Staphyloccus, Streptococcus, Torulopsis, Weissella or combinations thereof. In particular, the present invention employs probiotic microorganisms which include at least one of the Lactobacillus microbial strains selected from the group consisting of L. acidophilus, L. brevis, L. bulgaricus, L. casei, L. fermentum, L. helviticus, L. plantarum, L. leichmannii, L. salivarius and L. cellobiosus or combinations thereof; at least one of the Bifidobacterium strains selected from the group consisting of B. bifidum, B. longum and B. infantis or their combinations thereof; and at least one of the said Streptococcus strains selected from the group consisting of S. thermophilus, S. diacetilactis, S. cremoris, S. durans and S. faecalis or combinations thereof. In specific embodiments, the probiotic microorganism of the present invention comprise at least one of the bacterial strains including, but not limited to Lactobacillus acidophilus ATCC 4356 strain, Bifidobacterium longum ATCC 15707 strain and Streptococcus thermophilus ATCC 19258 strain or combinations thereof.

The term “prebiotic” or “prebiotic component” as used herein, is defined according to Food and Agricultural Organisation of the United Nations (hereinafter referred to as FAO) and WHO guidelines as a non-viable food component that confer health benefit's on the host associated with modulation of the microbiota. Prebiotics belong to a group of diverse carbohydrate ingredients and some sources include, but not limited to soybeans, inulin sources (like Jerusalem artichoke, chicory roots etc.), raw oats, unrefined barley, yacon, non-digestible carbohydrates and in particular non-digestible carbohydrates (J. Food Sci. Technol. 2015; 52(12):7557-7587; Pokusaeva et al., Gen. Nutr. 2011; 6(3):285-306). Within the context of the present invention and as used herein, the term “prebiotic” includes non-digestible carbohydrates, oligosaccharides and polysaccharides and in particular, includes, but not limited to, an oligosaccharide selected from the group consisting of a fructooligosaccharide, inulin, pectic polysaccharide, a mannan, a beta-glucan, a pentosan, an arabinan, a galactan, a fiber source such as apple fiber, oat gum, pectin or gaur gum or combinations thereof. Exemplary prebiotic of the present invention include an oligosaccharide, preferably a fructooligosaccharide. The present invention may also include a fructooligosaccharide selected from the group consisting of soy fructooligosaccharide, banana fiber or combinations thereof. The pharmaceutical combination of the present invention, the pharmaceutical composition comprising the said pharmaceutical combination and the methods of the present invention comprise at least one probiotic in combination with at least one prebiotic.

Fructooligosaccharides (hereinafter referred to as FOS) are polysaccharides composed primarily of fructose monosaccharides bonded together by 1-β-D-fructofuranosyl linkages. Their chemical structure consists of a chain of fructose units with a terminal glucose unit linked by β(3-2-1)glycosidic bonds, indicating that they cannot be hydrolysed by human digestive enzymes specific for glycosidic bonds. There are three categories of FOS, each of which is structurally distinct: inulin, having a polymerization of 2 to 60 monomers of fructose; oligofrumose produced by enzymatic hydrolysis of inulin and defined as a fraction of oligosaccharides with degree of polymerization lower than 20; and short chain FOS specifically defined as mixed chains of fructosyl with a glycose terminal unit; having a maximum of 5 units and derived from sugar through natural fermentation processes. FOS are available in some foods such as bananas, garlic, onion, tomato, asparagus, artichoke, leek, honey, rye, brown sugar, barley, triticale, beer, lettuce, chicory, burdock, beetroot, apples, bulbs like red lilies, yacon and oats, with onion being the food with the highest levels of FOS (V. Sridevi et al, J. Pharm. Research 2014; 8(3): 321-330).

The term “proteolytic enzyme”, as used herein, also referred to as “protease enzyme”, “protease”, “proteinase” or “peptidase” interchangeably throughout the specification are a group of enzymes that break the long chain-like molecules of proteins into shorter fragments (peptides) and eventually into their components, amino acids. Within the context of the present invention and as used herein, the term “proteolytic enzyme” is defined as an enzyme derived from a bacterial source or a fungal source and is capable of breaking down proteins and their degradation products, polypeptides and peptides, by hydrolysis and is active in a pH environment ranging from 4.5 to 6.8. My copending Indian patent application number 202041004499 relates to a therapeutic composition comprising the proteolytic enzyme comprising B. subtilis for use in the treatment of renal diseases and disorders, wherein the renal disease or a disorder is CKD. The proteolytic enzyme of the present invention may be selected from, but not limited to, pepsin, trypsin, chymotrypsin, an enzyme obtained from a fungal strain or a bacterial strain and an enzyme extracted from fruits or stem of Ananas comosus. Within the context of the present invention, the proteolytic enzyme of the present invention is a blend of a protease enzyme extracted from a bacterial strain, B. subtilis and an enzyme bromelain extract obtained from fruits of Ananas comosus and exhibit proteolytic action on protein substrate at a pH ranging from 4.5 to 8, and preferably, at a pH range of 5.5 to 6.8 and at a temperature of 35 to 38° C., preferably 37° C., ensuring maximum breakdown of proteins into di and tri peptides providing therapeutic benefits in subjects suffering from CKD. Bromelain can be obtained from either fruits of Ananas comosus (Ravindra Babu et al., Chemical Engineering and Process, 2008; 47:83-89) or stem of Ananas comosus. In accordance with an embodiment, the proteolytic enzyme of the present invention is obtained from a bacterial strain, preferably bacillus strain and more particularly, Bacillus subtilis ATCC 11774. In accordance with another embodiment, the proteolytic enzyme bromelain is extracted from fruits of Ananas comosus. In accordance with a further specific embodiment, the proteolytic enzyme of the present invention is Bacillus subtilis ATCC 11774 strain comprising bacterial protease whole cell in combination with bromelain extract obtained from fruits of Ananas comosus having a protease activity of 25,000 to 70,000 HUT.

The term “extract” or “bromelain extract” as used herein is intended to mean a concentrate of the bromelain extract components derived from the fruits or stem of Ananas comosus (pineapple).

The term “synbiotic” is a mixture of a “probiotic” and a “prebiotic” providing a combinative effect of both the components. Within the context of the present invention and as used herein, the term “synbiotic” is a synergistic combination comprising at least one probiotic and at least one prebiotic, wherein the “probiotic” and the “prebiotic” combine together and exert a combinative or a synergistic effect of the ingredients and their therapeutic effects. The synbiotic component of the present invention in combination with the “proteolytic enzyme” further provides a combinative effect of all the components and therapeutic effects.

The term “enzobiotic” as used herein is a synergistic combination comprising a “synbiotic” and an “enzyme”, in particular, the “proteolytic enzyme” of the present invention. Within the context of the present invention and as used herein the term “enzobiotic”, “enzobiotic therapeutic combination”, “therapeutic combination” or “said combination” used interchangeably throughout the specification is a synergistic combination comprising a “synbiotic” comprising at least one probiotic and at least one prebiotic, and a “proteolytic enzyme”, wherein the “probiotic”, the “prebiotic” and the “proteolytic enzyme” combine together and exert a combinative or a synergistic effect of the ingredients and their therapeutic effects.

Within the context of the present invention and as used herein the term “enzobiotic therapeutic composition”, “therapeutic composition”, “composition of the present invention”, and the “said composition”, used interchangeably throughout the specification is a synergistic composition comprising the said enzobiotic combination and pharmaceutically acceptable carriers in synergistically effective amounts, wherein the “probiotic”, the “prebiotic”, “proteolyse enzyme” and the pharmaceutical carrier/s combine together to exert a synergistic effect of the ingredients and their therapeutic effects. The composition of the present invention is suitable but not limited to use as a therapeutic composition or a therapeutic supplement or a nutritional supplement or a food supplement.

Within the context of the present invention, the term “micronutrients” refers to a group of nutrients required by the body in minute quantities and include, vitamins and minerals. Vitamins are organic compounds made by plants and animals and are broken down by heat, acid or air and minerals are inorganic, exist in soil or water and cannot be broken down. The foods we consume derived from plants and animals provide us the vitamins they created or the minerals they absorbed. The vitamins are required in the body for energy production, immune function, blood clotting and other functions. The minerals are necessary in growth, bone health, fluid balance and other processes. Within the context of the present invention and as used herein, the term “Vitamin” includes any of the fat-soluble or water-soluble organic substances, including but not limited to Vitamin A, Vitamin B1 (thiamine), Vitamin B2 (riboflavin), Vitamin B3 (niacin or niacinamide), Vitamin B5 (pantothenic acid), Vitamin B6 (pyridoxine or pyridoxamine or pyridoxine hydrochloride), Vitamin B7 (biotin), Vitamin B9 (folic acid) and Vitamin B12 (cyanocobalamin and cobalamins), Vitamin C (ascorbic acid), Vitamin D, Vitamin E, Vitamin K, which are essential in minute quantities for normal growth and activity of the body and are obtained naturally from plant and animal foods or synthetically made, pro-vitamins, derivatives, analogs. Within the context of the present invention and as used herein, the term mineral includes any of the macrominerals chosen from calcium, phosphorus, magnesium, sodium, chloride, potassium and sulfur and the trace minerals chosen from iron, manganese, copper, zinc, iodine, fluoride and selenium. In particular embodiments, at least one of the vitamins or at least one of the minerals can be incorporated as a further therapeutic agent in the enzobiotic therapeutic combination or the therapeutic composition of the present invention.

Within the context of the present invention and as used herein, the term “microorganism” or “microbe” includes a bacterium, yeast and/or fungi, protozoa, yeast, mold, mildew, a cell growth medium with the microorganism or a cell growth medium in which microorganism was cultivated.

The term “therapeutically effective amount” as used herein, in the present invention generally refers to the amount of an active ingredient, i.e. a probiotic, a prebiotic, a proteolytic or protease enzyme to be incorporated in the enzobiotic therapeutic combination or the enzobiotic therapeutic composition comprising the said combination thereof, that will elicit the biological or medical response in a subject, when treated with the therapeutic combination or the composition of the present invention. In particular, the term “therapeutically effective amount” includes the amount of an active ingredient which is sufficient to induce a positive modification in the disease or condition to be treated and significantly improves the condition to be treated, i.e. chronic kidney disease but low enough to avoid side effects, if any (at a reasonable benefit/risk ratio), within the scope of a sound medical judgement. The therapeutically effective amount of the combination or composition may vary with the particular condition being treated or prevented, the duration of the treatment, the nature of the concurrent therapy, the specific combination or composition employed, the therapeutically acceptable carriers and other factors.

The term “therapeutically acceptable carrier” (or alternatively referred to as “therapeutically acceptable excipient”) as used herein means a non-toxic, inert, solid, semi-solid, diluent, encapsulating material or formulation auxiliary of any type. Some examples of materials which can serve as therapeutically acceptable carriers or excipients are sugars such as lactose, glucose, and sucrose; starches such as corn starch and potato starch; cellulose and its derivatives such as sodium carboxymethyl cellulose, ethyl cellulose and cellulose acetate; malt; gelatin; talc; as well as other non-toxic compatible lubricants such as sodium lauryl sulfate and magnesium stearate, as well as anticaking agents, binders, buffers, coating agents, colouring agents, emollients, fillers, flavouring agents, free flowing agents, stabilizers, glidants, plasticizers, releasing agents, surfactants, sweetening and perfuming agents; preservatives and antioxidants can also be present in the composition, according to the judgment of the formulator.

### EMBODIMENTS

In one embodiment, the present invention provides an enzobiotic therapeutic combination comprising a therapeutically effective amount of:
(i) a synbiotic comprising at least one probiotic and at least one prebiotic; and
(ii) at least one proteolytic enzyme.

In one embodiment, the present invention provides a therapeutic combination comprising:
(i) a synbiotic comprising at least one probiotic and at least one prebiotic; and (ii) at least one proteolytic enzyme,
wherein, said combination is capable of reducing protein bound uremic toxins, p-cresol (para cresol) and indoxyl sulphate; and wherein, said combination when administered to a subject in need thereof provides nephroprotective effect.

In one embodiment, the present invention provides an enzobiotic therapeutic combination comprising a therapeutically effective amount of:
(i) a synbiotic comprising at least one probiotic and at least one prebiotic; and (ii) at least one proteolytic enzyme,
wherein, said combination is capable of reducing the concentration of protein bound uremic toxins, p-cresol by 20 to 30% and indoxyl sulphate by 500 to 1500 μg/ml and wherein, said combination when administered to a subject in need thereof provides nephroprotective effect.

In a particular embodiment, the present invention provides an enzobiotic therapeutic combination, wherein, said combination is capable of reducing p-cresol concentration by 23% and indoxyl sulphate concentration by 500 μg/ml; and wherein, said combination when administered to a subject in need thereof provides nephroprotective effect.

In a particular embodiment, the present invention provides an enzobiotic therapeutic combination, wherein the probiotic is at least one of the said Lactobacillus strains selected from the group consisting of L. acidophilus, L. brevis, L. bulgaricus, L. casei, L. fermentum, L. helviticus, L. plantarum, L. leichmannii, L. salivarius and L. cellobiosus.

In a specific embodiment, the present invention provides an enzobiotic therapeutic combination, wherein the probiotic is a Lactobacillus strain, preferably Lactobacillus acidophilus ATCC 4356 strain.

In a further specific embodiment, the present invention provides an enzobiotic therapeutic combination, wherein the probiotic is a Lactobacillus strain, preferably Lactobacillus acidophilus ATCC 4356 strain in an amount ranging from 15 to 45 wt %.

In a particular embodiment, the present invention provides an enzobiotic therapeutic combination, wherein the probiotic is at least one of the said Bifidobacterium strains selected from the group consisting of B. bifidum, B. longum and B. infantis.

In a specific embodiment, the present invention provides an enzobiotic therapeutic combination, wherein the probiotic is a Bifidobacterium strain, preferably Bifidobacterium longum ATCC 15707 strain.

In a further specific embodiment, the present invention provides an enzobiotic therapeutic combination, wherein the probiotic is a Bifidobacterium strain, preferably Bifidobacterium longum ATCC 15707 strain, in an amount ranging from 15 to 45 wt %.

In a particular embodiment, the present invention provides an enzobiotic therapeutic combination, wherein the probiotic is at least one of the said Streptococcus strains selected from the group consisting of S. thermophilus, S. diacetilactis, S. cremoris, S. durans and S. faecalis.

In a specific embodiment, the present invention provides a therapeutic combination, wherein the probiotic is a Streptococcus strain, preferably Streptococcus thermophilus ATCC 19258 strain.

In a further specific embodiment, the present invention provides a therapeutic combination, wherein the probiotic is a Streptococcus strain, preferably Streptococcus thermophilus ATCC 19258 strain present in an amount ranging from 7 to 30 wt %.

In a further specific embodiment, the present invention provides an enzobiotic therapeutic combination, wherein the probiotic is at least one of the bacterial strains selected from Lactobacillus acidophilus ATCC 4356 strain, Bifidobacterium longum ATCC 15707 strain and Streptococcus thermophilus ATCC 19258 strain or combinations thereof.

In a particular embodiment, the present invention provides an enzobiotic therapeutic combination, wherein the prebiotic is an oligosaccharide selected from the group consisting of a fructooligosaccharide, inulin, pectic polysaccharide, a mannan, a beta-glucan, a pentosan, an arabinan, a galactan or combinations thereof.

In a specific embodiment, the present invention provides an enzobiotic therapeutic combination, wherein the prebiotic is an oligosaccharide, preferably a fructooligosaccharide.

In a further specific embodiment, the present invention provides an enzobiotic therapeutic combination, wherein the prebiotic is a fructooligosaccharide, in an amount ranging from 15 to 25 wt %.

In a particular embodiment, the present invention provides an enzobiotic therapeutic combination, wherein the proteolytic enzyme is selected from the group consisting of pepsin, trypsin, chymotrypsin, an enzyme obtained from a fungal strain or a bacterial strain and an enzyme extracted from fruits or stem of Ananas comosus.

In a particular embodiment, the present invention provides an enzobiotic therapeutic combination, wherein the proteolytic enzyme is obtained from a bacterial strain, preferably Bacillus strain.

In a specific embodiment, the present invention provides a therapeutic combination, wherein the proteolytic enzyme is obtained from a Bacillus strain, preferably Bacillus subtilis ATCC 11774 strain.

In a particular embodiment, the present invention provides an enzobiotic therapeutic combination, wherein the proteolytic enzyme is bromelain extract obtained from the fruits of Ananas comosus.

In a further specific embodiment, the present invention provides a therapeutic combination, wherein the proteolytic enzyme is obtained from a bacterial strain, preferably a Bacillus subtilis ATCC 11774 strain comprising bacterial protease whole cell in combination with bromelain extract obtained from the fruits of Ananas comosus.

In a further specific embodiment, the present invention provides a therapeutic combination, wherein the proteolytic enzyme is obtained from a bacterial strain, preferably a Bacillus subtilis ATCC 11774 strain comprising bacterial protease whole cell in combination with bromelain extract obtained from the fruits of Ananas comosus in an amount ranging from 15 to 45 wt %.

In a particular embodiment, the present invention provides an enzobiotic therapeutic combination, wherein, (i) the synbiotic comprises of: a) the probiotic selected from at least one of the bacterial strains selected from Lactobacillus acidophilus ATCC 4356 strain, Bifidobacterium longum ATCC 15707 strain and Streptococcus thermophilus ATCC 19258 strain or combinations thereof; b) the prebiotic, preferably, a fructooligosaccharide; and (ii) the proteolytic enzyme obtained from a bacterial strain, preferably Bacillus subtilis ATCC 11774 strain comprising bacterial protease whole cell in combination with bromelain extract obtained from the fruits of Ananas comosus.

In another particular embodiment, the present invention provides an enzobiotic therapeutic combination, wherein the combination comprises (i) a synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain; b) 15 to 25 wt % of fructooligosaccharide; and (ii) 15 to 45 wt % of Bacillus subtilis ATCC 11774 strain comprising bacterial protease whole cell in combination with bromelain extract obtained from the fruits of Ananas comosus.

In another particular embodiment, the present invention provides an enzobiotic therapeutic combination, wherein the combination comprises (i) a synbiotic comprising a) 17 to 20 wt % of Lactobacillus acidophilus ATCC 4356 strain, 18 to 22 wt % of Bifidobacterium longum ATCC 15707 strain and 9 to 11 wt % of Streptococcus thermophilus ATCC 19258 strain; b) 18 to 22 wt % of fructooligosaccharide; and (ii) 30 to 40 wt % of Bacillus subtilis ATCC 11774 strain comprising bacterial protease whole cell in combination with bromelain extract obtained from the fruits of Ananas comosus having a protease activity of 35,000 to 70,000 HUT.

In another particular embodiment, the present invention provides an enzobiotic therapeutic combination, wherein the combination comprises (i) a synbiotic comprising a) 26.6 to 35 wt % of Lactobacillus acidophilus ATCC 4356 strain; 30 to 45 wt % of Bifidobacterium longum ATCC 15707 strain; 10 to 13.33 wt % of Streptococcus thermophilus ATCC 19258 strain; b) 7.5 to 15 wt % of fructosaccharide; and (ii) 25 to 45 wt % of Bacillus subtilis ATCC 11774 strain comprising protease whole cell in combination with bromelain extract obtained from the fruits of Ananas omosus having a protease activity of 25,000 to 70,000 HUT.

In a further particular embodiment, the present invention provides an enzobiotic therapeutic combination, wherein the combination comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) 100 to 500 mg of fructooligosaccharide; and (ii) 50 to 200 mg of Bacillus subtilis ATCC 11774 strain comprising bacterial protease whole cell in combination with bromelain extract obtained from fruits of Ananas comosus having a protease activity of 25,000 to 70,000 HUT.

In a still further particular embodiment, the present invention provides an enzobiotic therapeutic combination, wherein the combination comprises (i) a synbiotic comprising a) 30 billion counts of cells of Lactobacillus acidophilus ATCC 4356 strain, 30 billion counts of cells of Bifidobacterium longum ATCC 15707 strain and 30 billion counts of cells of Streptococcus thermophilus ATCC 19258 strain; b) 100 to 200 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, the present invention provides an enzobiotic therapeutic combination, wherein the combination comprises (i) a synbiotic comprising a) 20 billion counts of cells of probiotic Lactobacillus acidophilus ATCC 4356 strain, 20 billion counts of cells of Bifidobacterium longum ATCC 15707 strain and 20 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, the present invention provides an enzobiotic therapeutic combination, wherein the combination comprises (i) a synbiotic comprising a) 15 billion counts of cells of Lactobacillus acidophilus ATCC 4356 strain, 15 billion counts of cells of Bifidobacterium longum ATCC 15707 strain and 15 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, the present invention provides an enzobiotic therapeutic combination, wherein the combination comprises (i) a synbiotic comprising a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, the present invention provides an enzobiotic therapeutic combination, wherein the combination comprises (i) a synbiotic comprising a) 5 to 10 billion counts of cells of Lactobacillus acidophilus ATCC 4356 strain, 5 to 10 billion counts of cells of Bifidobacterium longum ATCC 15707 strain and 5 to 7.5 billion counts of cells of Streptococcus thermophilus ATCC 19258 strain; b) 100 mg of fructooligosaccharide; and (ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT.

In a still further particular embodiment, the present invention provides an enzobiotic therapeutic combination, wherein the combination comprises (i) a synbiotic comprising a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain; b) 100 mg of fructooligosaccharide; and (ii) 75 to 150 mg of Bacillus subtilis ATCC 11774 strain comprising bacterial protease whole cell in combination with bromelain extract obtained from fruits of Ananas comosus having a protease activity of 26,250 to 52,500 HUT.

In a particular embodiment, the present invention provides a therapeutic combination, wherein, the further therapeutic agent is selected from at least one of a probiotic, a prebiotic, a synbiotic comprising at least one probiotic and a prebiotic and a micronutrient selected from a vitamin and a mineral.

In another embodiment, the present invention provides an enzobiotic therapeutic composition comprising the said therapeutic combination; and at least one therapeutically acceptable carrier.

In a yet another embodiment, the present invention provides an enzobiotic therapeutic composition comprising an enzobiotic therapeutic combination, wherein the said combination comprises:
(i) a synbiotic comprising at least one probiotic and at least one prebiotic; and (ii) at least one proteolytic enzyme; and at least one therapeutically acceptable carrier or excipient, wherein, said composition is capable of reducing protein bound uremic toxins, p-cresol concentration in the range of 20 to 30% and indoxyl sulphate in a concentration range of 500 to 1500 μg/ml; and wherein, said composition when administered to a subject in need thereof provides nephroprotective effect.

In a particular embodiment, the present invention provides an enzobiotic therapeutic composition, wherein, said composition is capable of reducing the concentration of p-cresol by 23% and indoxyl sulphate by 500 μg/ml and wherein, said composition when administered to a subject in need thereof provides nephroprotective effect.

In a particular embodiment, the present invention provides an enzobiotic therapeutic composition, wherein the probiotic is at least one of the said Lactobacillus strains selected from the group consisting of L. acidophilus, L. brevis, L. bulgaricus, L. casei, L. fermentum, L. helviticus, L. plantarum, L. leichmannii, L. salivarius and L. cellobiosus. In a particular embodiment, the present invention provides an enzobiotic therapeutic composition, wherein the probiotic is a Lactobacillus strain, preferably Lactobacillus acidophilus ATCC 4356 strain and Lactobacillus plantarum. In a specific embodiment, the present invention provides an enzobiotic therapeutic composition, wherein the probiotic is a Lactobacillus strain, preferably Lactobacillus acidophilus ATCC 4356 strain. In a further specific embodiment, the present invention provides an enzobiotic therapeutic composition, wherein the probiotic a Lactobacillus strain, preferably Lactobacillus acidophilus ATCC 4356 strain present in an amount ranging from 15 to 45 wt %.

In a particular embodiment, the present invention provides an enzobiotic therapeutic composition, wherein the probiotic is at least one of the said Bifidobacterium strains selected from the group consisting of B. bifidum, B. longum and B. infantis. In a specific embodiment, the present invention provides an enzobiotic therapeutic composition, wherein the probiotic is a Bifidobacterium strain, preferably Bifidobacterium longum ATCC 15707 strain. In a further specific embodiment, the present invention provides an enzobiotic therapeutic composition, wherein the probiotic is a Bifidobacterium strain, preferably Bifidobacterium longum ATCC 15707 strain, present in an amount ranging from 15 to 45 wt %.

In a particular embodiment, the present invention provides an enzobiotic therapeutic composition, wherein the probiotic is at least one of the said Streptococcus strains selected from the group consisting of S. thermophilus, S. diacetilactis, S. cremoris, S. durans and S. faecalis. In a specific embodiment, the present invention provides an enzobiotic therapeutic composition, wherein the probiotic is a Streptococcus strain, preferably Streptococcus thermophilus ATCC 19258 strain. In a further specific embodiment, the present invention provides an enzobiotic therapeutic composition, wherein the probiotic is a Streptococcus strain, preferably Streptococcus thermophilus ATCC 19258 strain, present in an amount ranging from 7 to 30 wt %.

In a further specific embodiment, the present invention provides an enzobiotic therapeutic composition, wherein the probiotic is at least one of the bacterial strains selected from Lactobacillus acidophilus ATCC 4356 strain, Bifidobacterium longum ATCC 15707 strain and Streptococcus thermophilus ATCC 19258 strain or combinations thereof.

In a particular embodiment, the present invention provides an enzobiotic therapeutic composition, wherein the prebiotic is an oligosaccharide selected from the group consisting of a fructooligosachharide, inulin, pectic polysaccharide, a mannan, a beta-glucan, a pentosan, an arabinan, a galactan or combinations thereof. In a specific embodiment, the present invention provides an enzobiotic therapeutic composition, wherein the prebiotic is an oligosaccharide, preferably a fructooligosachharide. In a specific embodiment, the present invention provides an enzobiotic therapeutic composition, wherein the prebiotic is a fructooligosaccharide present in an amount ranging from 15 to 25 wt %.

In a particular embodiment, the present invention provides an enzobiotic therapeutic composition, wherein the proteolytic enzyme is selected from the group consisting of pepsin, trypsin, chymotrypsin, an enzyme obtained from a fungal strain or a bacterial strain and an enzyme extracted from fruits or stem of Ananas comosus. In a particular embodiment, the present invention provides an enzobiotic therapeutic composition, wherein the proteolytic enzyme is obtained from a bacterial strain, preferably Bacillus strain. In a specific embodiment, the present invention provides a therapeutic composition, wherein the proteolytic enzyme is obtained from a bacterial strain, preferably, Bacillus subtilis ATCC 11774 strain. In a specific embodiment, the present invention provides an enzobiotic therapeutic composition, wherein the proteolytic enzyme is bromelain extract obtained from the fruits of Ananas comosus. In a further specific embodiment, the present invention provides a therapeutic composition, wherein the proteolytic enzyme is obtained from Bacillus subtilis ATCC 11774 strain comprising bacterial protease whole cell in combination with bromelain extract obtained from the fruits of Ananas comosus. In a further specific embodiment, the present invention provides a therapeutic composition, wherein the proteolytic enzyme is obtained from Bacillus subtilis ATCC 11774 strain comprising bacterial protease whole cell in combination with bromelain extract obtained from the fruits of Ananas comosus and present in an amount ranging from 15 to 45 wt %.

In a particular embodiment, the present invention provides an enzobiotic therapeutic composition comprising a therapeutically effective amount of: (i) a synbiotic comprising: a) the probiotic selected from at least one of the bacterial strains selected from Lactobacillus acidophilus ATCC 4356 strain, Bifidobacterium longum ATCC 15707 strain and Streptococcus thermophilus ATCC 19258 strain or combinations thereof; b) the prebiotic, preferably a fructooligosaccharide; and (ii) the proteolytic enzyme obtained from a bacterial strain, preferably a Bacillus subtilis ATCC 11774 strain comprising bacterial protease whole cell in combination with bromelain extract obtained from the fruits of Ananas comosus and at least one therapeutically acceptable carrier or excipient.

In another particular embodiment, the present invention provides an enzobiotic therapeutic composition, wherein the composition comprises (i) a synbiotic comprising a) 15 to 45 wt % of Lactobacillus acidophilus ATCC 4356 strain, 15 to 45 wt % of the probiotic Bifidobacterium longum ATCC 15707 strain, 7 to 30 wt % of Streptococcus thermophilus ATCC 19258 strain; b) 15 to 25 wt % of a fructooligosaccharide; and (ii) 15 to 45 wt % of a proteolytic enzyme obtained from a Bacillus subtilis ATCC 11774 strain comprising bacterial protease whole cell in combination with bromelain extract obtained from the fruits of Ananas comosus and at least one therapeutically acceptable carrier.

In a further particular embodiment, the present invention provides an enzobiotic therapeutic composition, wherein the composition comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain, 5 to 35 billion counts of cells of Streptococcus thermophilus ATCC 19258 strain; b) 100 to 500 mg of fructooligosaccharide; and (ii) 50 to 200 mg of Bacillus subtilis ATCC 11774 strain comprising bacterial protease whole cell in combination with bromelain extract obtained from the fruits of Ananas comosus having a protease activity of 25,000 to 70,000 HUT and at least one therapeutically acceptable carrier.

In a still further particular embodiment, the present invention provides an enzobiotic therapeutic composition, wherein the composition comprises (i) a synbiotic comprising a) 30 billion counts of cells of probiotic Lactobacillus acidophilus ATCC 4356 strain, 30 billion counts of cells of Bifidobacterium longum ATCC 15707 strain and 30 billion counts of cells of Streptococcus thermophilus ATCC 19258 strain; b) 100 to 200 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT and at least one therapeutically acceptable carrier.

In a still further particular embodiment, the present invention provides an enzobiotic therapeutic composition, wherein the composition comprises (i) a synbiotic comprising a) 20 billion counts of cells of Lactobacillus acidophilus ATCC 4356 strain, 20 billion counts of cells of Bifidobacterium longum ATCC 15707 strain and 20 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT and at least one therapeutically acceptable carrier.

In a still further particular embodiment, the present invention provides an enzobiotic therapeutic composition, wherein the composition comprises (i) a synbiotic comprising a) 15 billion counts of cells of Lactobacillus acidophilus ATCC 4356 strain, 15 billion counts of cells of Bifidobacterium longum ATCC 15707 strain and 15 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT and at least one therapeutically acceptable carrier.

In a still further particular embodiment, the present invention provides an enzobiotic therapeutic composition, wherein the composition comprises (i) a synbiotic comprising a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT and at least one therapeutically acceptable carrier.

In a still further particular embodiment, the present invention provides an enzobiotic therapeutic composition, wherein the composition comprises (i) a synbiotic comprising a) 5 to 10 billion counts of cells of Lactobacillus acidophilus ATCC 4356 strain, 5 to 10 billion counts of cells of Bifidobacterium longum ATCC 15707 strain and 5 to 7.5 billion counts of cells of Streptococcus thermophilus ATCC 19258 strain; b) 100 mg of fructooligosaccharide; and (ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT and at least one therapeutically acceptable carrier.

In a still further particular embodiment, the present invention provides an enzobiotic therapeutic composition, wherein the composition comprises (i) a synbiotic comprising a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain; b) 100 mg of fructooligosaccharide; and (ii) 75 to 150 mg of Bacillus subtilis ATCC 11774 strain comprising bacterial protease whole cell in combination with bromelain extract obtained from fruits of Ananas comosus having a protease activity of 26,250 to 52,500 HUT.

In another embodiment, the present invention provides an enzobiotic therapeutic composition comprising the said enzobiotic therapeutic combination; and at least one further therapeutically active agent and at least one therapeutically acceptable carrier.

In a particular embodiment, the present invention provides a therapeutic composition, wherein, the at least one further therapeutic agent is selected from at least one of a probiotic, a prebiotic or a synbiotic comprising at least one probiotic and a prebiotic, a vitamin and a mineral.

In a particular embodiment, the present invention provides a therapeutic composition, wherein the composition is formulated in the form of an oral tablet, oral capsule, powder, sachet, liquid syrup, health drink and a nutritional bar.

In a specific embodiment, the present invention provides an enzobiotic therapeutic composition in the form of an oral capsule.

In another specific embodiment, the present invention provides an enzobiotic therapeutic composition in the form of a sachet.

The pharmaceutically acceptable carriers that may be included in the enzobiotic therapeutic composition include: (1) sugars such as lactose, glucose, and sucrose; (2) cellulose and its derivatives such as sodium carboxymethyl cellulose, ethyl cellulose and cellulose acetate; (3) malt; (4) gelatin; (5) talc; as well as other non-toxic compatible lubricants such as sodium lauryl sulfate and magnesium stearate. Further, the enzobiotic therapeutic composition may also contain additives such as anticaking agents, fillers, releasing agents, coating agents, stabilizers, binders, buffers, surfactants, glidants, plasticizers, fillers, emollients, colouring agents, sweetening agents, flavoring agents and perfuming agents; preservatives and antioxidants can also be present in the composition.

The therapeutically acceptable filler may be selected from, but not limited to, starch, pre-gelatinized starch, cellulose, microcrystalline cellulose, sorbitol, manitol, xylitol, sucrose, maltose, lactulose, fructose, dextrose, maltodextrin, sucralose and the like or their combinations thereof. The therapeutically acceptable binder may be selected from, but not limited to, starch, natural sugar, cellulose derivatives, gelatin, polyethylene glycol, natural and synthetic gums, waxes, sodium alginate, alcohol and the like or their combinations thereof. Therapeutically acceptable sweetener may be chosen from, but not limited to, alitame, aspartame, dextrose, D-tryptophan, dextrose, fructose, galactose, glycerol, glucose, glycyrrhizin, isomalt, xylose, xylitol, lactose, lactitol, maltose, maltitol, maltodextrin, neotame, saccharin, sorbitol, sucrose, sucralose and the like or their combinations thereof. Therapeutically acceptable anti-caking agent may be selected from the group consisting of magnesium stearate, colloidal starch, silicon dioxide, tribasic calcium phosphate, powdered cellulose, magnesium trisilicate, and the like or their combinations thereof. Therapeutically acceptable antioxidants may be selected from, but not limited to, ascorbic acid, beta-carotene, butylated hydroxytoluene (BHT), butylated hydroxyanisole (BHA), propyl gallate, sodium metabisulphate, thiourea, tocopherols and the like or their combinations thereof. Therapeutically acceptable flavouring agent may be selected from, but not limited to, ascorbic acid, apple, apricot, banana, bargamot, basil, blackberry, black currant, blueberry, citric acid, camille, cherry, cinnamon, cranberry cumin, dill, eucalyptus, fennel, fumaric acid, gooseberry, grapefruit, lactic acid, lavender, lemon, lingon berries, malic acid, menthol, orange, parsley, passion fruit, peach, peppermint, red currant, salvia, spearmint, strawberry, tartaric acid, thymol, vanilla or their combinations thereof. Therapeutically acceptable preservative may be selected from, but not limited to, parabens such as methyl paraben and propyl paraben, sodium benzoate, phenol, boric acid and salts thereof, citric acid and salts thereof, sorbic acid and salts thereof, neutral preservatives and the like or their combinations thereof. Therapeutically acceptable free flowing agent may be selected from, but not limited to, talc, silica and the like or their combinations thereof.

In a particular embodiment, the present invention provides a therapeutic composition, wherein the therapeutically acceptable carrier is at least one carrier selected from an anti caking agent, a filler, a flavouring agent, a free flowing agent and other optional additives.

In a specific embodiment, the present invention provides a therapeutic composition, wherein the therapeutically acceptable carrier is selected from at least one anticaking agent selected from the group consisting of magnesium stearate, starch or modified starches, a filler selected from the group consisting of microcrystalline cellulose, maltodextrin and sucralose, a free flowing agent, preferably talc, a flavouring agent, preferably, orange flavour and other optional additives.

In a specific embodiment, the present invention provides an enzobiotic oral capsule, comprising:
(i) a) 17 to 20 wt % of Lactobacillus acidophilus ATCC 4356 strain; 18 to 22 wt % of Bifidobacterium longum ATCC 15707 strain; 9 to 11 wt % of Streptococcus thermophilus ATCC 19258 strain; b) 18 to 22 wt % of fructooligosaccharide;
(ii) 30 to 40 wt % of Bacillus subtilis ATCC 11774 strain comprising bacterial protease whole cell in combination with bromelain extract obtained from the fruits of Ananas comosus having a protease activity of 35,000 to 70,000 HUT; and
(iii) filler, preferably microcrystalline cellulose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a specific embodiment, the present invention provides an enzobiotic sachet, comprising:
(i) a) 26.6 to 35 wt % of Lactobacillus acidophilus ATCC 4356 strain; 30 to 45 wt % of Bifidobacterium longum ATCC 15707 strain; 10 to 13.33 wt % of Streptococcus thermophilus ATCC 19258 strain; b) 7.5 to 15 wt % of fructosaccharide;
(ii) 25 to 45 wt % of Bacillus subtilis ATCC 11774 strain comprising bacterial protease whole cell in combination with bromelain extract obtained from the fruits of Ananas omosus having a protease activity of 25,000 to 70,000 HUT;
(iii) filler, preferably maltodextrin and sucralose, 1 to 5 wt % of magnesium stearate, 1 to 2 wt % of talc and orange flavour; wherein each of the probiotics, the prebiotic and the proteolytic enzyme formulated along with the filler together comprise 90 to 95 wt % of the composition.

In an embodiment, the present invention provides an enzobiotic kit, wherein, (i) a synbiotic comprising at least one probiotic and at least one prebiotic; and (ii) at least one proteolytic enzyme, wherein the synbiotic administered in combination with the proteolytic enzyme is capable of reducing protein bound uremic toxins, p-cresol and indoxyl sulphate and providing nephroprotective effect in a subject more than when administered alone.

In another embodiment, the present invention provides an enzobiotic kit, wherein the kit comprises (i) a synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain; b) 15 to 25 wt % of fructooligosaccharide; and (ii) 15 to 45 wt % of a proteolytic enzyme obtained from a bacterial strain, preferably Bacillus subtilis ATCC 11774 strain comprising protease whole cell in combination with bromelain extract obtained from the fruits of Ananas comosus.

In a further embodiment, the present invention provides an enzobiotic kit, wherein the kit comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) 100 to 500 mg of fructooligosaccharide; and (ii) 50 to 200 mg of Bacillus subtilis ATCC 11774 strain comprising protease whole cell in combination with bromelain extract obtained from fruits of Ananas comosus having a bacterial protease activity of 25,000 to 70,000 HUT.

The term “subject” as used herein refers to an animal, preferably a mammal, and most preferably a human. The term “mammal” used herein refers to warm-blooded vertebrate animals of the class Mammalia, including humans, characterized by a covering of hair on the skin and, in the female, milk-producing mammary glands for nourishing the young. The term mammal includes animals such as cat, dog, rabbit, bear, fox, wolf, monkey, deer, mouse, pig as well as human. The term “patient” is often used herein to refer to any animal or mammal and preferably a human having or at risk for a medical condition that can benefit from the treatment.

The term “renal disorders” or “renal diseases” as used herein denotes the inability of the kidneys to perform excretory function leading to the retention of nitrogenous waste products from the blood. The United States National Kidney Foundation defines chronic kidney disease according to the presence or absence of kidney damage and level of kidney function, regardless of the type of kidney disease. The primary measure of kidney function is glomerular filtration rate (hereinafter referred to as “GFR”) which is often estimated as creatinine clearance from serum and urine creatinine concentrations. The term “chronic kidney disease” as used herein denotes a persistent impairment of kidney function, in other words, abnormally elevated serum creatinine for more than 3 months or calculated GFR less than 60 ml/min/1.73 m². It often involves a progressive loss of kidney function necessitating renal replacement therapy (dialysis or transplantation). When a patient needs renal replacement therapy, the condition is called end-stage renal disease (hereinafter referred to as “ESRD”) (Kidney International Supplements, 2013; 3:19-62; Scotland G, Cruickshank M, Jacobsen E, Cooper D, Fraser C, Shimonovich M, et al. Multiple-frequency bioimpedance devices for fluid management in people with chronic kidney disease receiving dialysis: a systematic review and economic evaluation, Health Technol. Assess., 2018; 22 (1); Chertow G M, et al., J. Am. Soc. Nephrol. 2005 November; 16(11):3365-70). The U.S. National Kidney Foundation classifies the stages of CKD based on calculated GFR, wherein the stage 1 CKD has calculated GFR as 90 ml/min/1.73 m² or more, stage 2 CKD having GFR 60 to 89 ml/min/1.73 m², Stage 3a having GFR of 45 to 59 ml/min/1.73 m², Stage 3b having GFR of 30 to 44 ml/min/1.73 m², stage 4 having GFR of 15 to 29 ml/min/1.73 m² and stage 5 having GFR of 15 ml/min/1.73 m² or less.

The term “treatment”, “treat” and “therapy” as used herein and the like refer to alleviate, slow the progression, prophylaxis, attenuation, ameliorate or cure of renal diseases or disorders, in particular, CKD and ESRD, improve cardiac performance and quality of life, by administering to a subject in need thereof, an enzobiotic combination of the present invention or an enzobiotic therapeutic composition of the present invention for the purposes of prophylactic and/or therapeutic treatment in a subject. The term “therapeutic treatment” pertains to administering treatment to a subject after manifestation of the unwanted condition, i.e. to a subject already suffering from renal diseases or disorders. The term “prophylaxis” or “prophylactic treatment” refers to administering treatment to a subject prior to clinical manifestation of the unwanted condition, i.e. disease or disorder or other unwanted state of the subject, who is not yet suffering from, but susceptible to, or otherwise at risk. The term, “effectiveness” or “efficacy” as used herein, refers to ability of the enzobiotic therapeutic combination or the enzobiotic therapeutic composition comprising the said combination, to produce a desired biological effect in a subject. For example, the term “effectiveness” refers to the ability of the enzobiotic therapeutic combination or the enzobiotic therapeutic composition comprising the said combination to prevent or treat the renal diseases or disorders in a subject, particularly the ability to reduce the uremic toxins in such subjects, reduce nitrogenous wastes from blood, improve cardiac performance, lipid performance, immunity, and quality of life. The term “effectiveness” further refers to the ability of the enzobiotic therapeutic combination or the enzobiotic therapeutic composition comprising the said combination to prevent or treat the renal diseases or disorders in a subject, particularly wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection. The term “effectiveness” also refers to the ability of the enzobiotic therapeutic combination or the enzobiotic therapeutic composition comprising the said combination to facilitate improved immunity, extended life and better recovery of subjects suffering from CKD in subjects suffering from SARS-CoV-2 or COVID-19 infection. The term “effectiveness” or “efficacy” also refers to the ability or beneficial effect of the enzobiotic therapeutic combination and the enzobiotic composition comprising the said combination in reducing the levels of nitrogenous waste products in the blood to normal range and thereby treating renal failure. For example, the normal levels of creatinine in the blood are in the range of 0.6 to 1.2 mg/dL for males and 0.5 to 1.1 mg/dL for females, normal levels of blood urea nitrogen (hereinafter referred to as BUN) is in the range of 7 to 18 mg/dL and the normal levels of protein in serum is in the range of 6 to 8 g/dL.

In an embodiment, the present invention provides a method of reducing protein bound uremic toxins, in a subject, comprising administering to a subject in need thereof, a therapeutically effective amount of an enzobiotic therapeutical combination, wherein the combination comprises a therapeutically effective amount of: (i) a synbiotic comprising at least one probiotic and at least one prebiotic; and (ii) at least one proteolytic enzyme. Administering the enzobiotic therapeutic combination of the present invention is effective in reducing the concentration of protein bound uremic toxins, p-cresol by 20 to 30 wt % and indoxyl sulphate by 500 to 1500 μg/ml in patients with CKD and ESRD. In a specific embodiment, the therapeutic combination of the present invention is effective in reducing the concentration of protein bound uremic toxins, p-cresol by 23% and indoxyl sulphate by 500 μg/ml in patients with CKD and ESRD.

In an embodiment, the present invention also relates to the method for removing nitrogenous waste products in a subject, comprising administering to a subject in need thereof, a therapeutically effective amount of an enzobiotic therapeutical combination, wherein the combination comprises a therapeutically effective amount of: (i) a synbiotic comprising at least one probiotic and at least one prebiotic; and (ii) at least one proteolytic enzyme. Administering a therapeutically effective amount of the enzobiotic combination of the invention and the enzobiotic composition comprising the said combination produces the beneficial effect of decreasing and reducing the levels of nitrogenous waste products in the blood to normal range and treating renal failure.

In another embodiment, the present invention provides a method for treatment of renal diseases or disorders, in a subject, comprising administering to a subject in need thereof a therapeutically effective amount of said therapeutical combination, wherein said combination comprises a therapeutically effective amount of: (i) a synbiotic comprising at least one probiotic and at least one prebiotic; and (ii) at least one proteolytic enzyme.

In a particular embodiment, the present invention provides a method, wherein the enzobiotic therapeutic composition, when administered, is capable of reducing the concentration of p-cresol by 20 to 30% and indoxyl sulphate by 500 to 1500 μg/ml and wherein, said composition when administered to a subject in need thereof provides nephroprotective effect.

In a specific embodiment, the present invention provides a method, wherein the enzobiotic therapeutic composition, when administered, is capable of reducing the concentration of p-cresol by 23% and indoxyl sulphate by 500 μg/ml and wherein, said composition when administered to a subject in need thereof provides nephroprotective effect.

In a particular embodiment, the administration comprises simultaneous, sequential or intermittent administration of the therapeutically effective amount of at least one probiotic, at least one prebiotic and at least one proteolytic enzyme. In a particular embodiment of the method, the probiotic is at least one of the said Lactobacillus strains selected from the group consisting of L. acidophilus, L. brevis, L. bulgaricus, L. casei, L. fermentum, L. helviticus, L. plantarum, L. leichmannii, L. salivarius and L. cellobiosus. In a specific embodiment, the probiotic is a Lactobacillus strain, preferably Lactobacillus plantarum. In a specific embodiment, the probiotic is a Lactobacillus strain, preferably Lactobacillus acidophilus ATCC 4356 strain. In a further specific embodiment, the probiotic is a Lactobacillus strain, preferably Lactobacillus acidophilus ATCC 4356 strain present in a therapeutically effective amount ranging from 15 to 45 wt %. In a particular embodiment of the method, the probiotic is at least one of the said Bifidobacterium strains selected from the group consisting of B. bifidum, B. longum and B. infantis. In a specific embodiment, the probiotic is a Bifidobacterium strain, preferably Bifidobacterium longum ATCC 15707 strain. In a further specific embodiment, the probiotic is a Bifidobacterium strain, preferably Bifidobacterium longum ATCC 15707 strain present in a therapeutically effective amount ranging from 15 to 45 wt %. In a particular embodiment of the method, the probiotic is at least one of the said Streptococcus strains selected from the group consisting of S. thermophilus, S. diacetilactis, S. cremoris, S. durans and S. faecalis. In a specific embodiment, the probiotic is a Streptococcus strain, preferably Streptococcus thermophilus ATCC 19258 strain. In a further specific embodiment, the probiotic is a Streptococcus strain, preferably Streptococcus thermophilus ATCC 19258 strain, present in a therapeutically effective amount ranging from 7 to 30 wt %. In a further specific embodiment of the method, the probiotic is at least one of the bacterial strains selected from Lactobacillus acidophilus ATCC 4356 strain, Bifidobacterium longum ATCC 15707 strain and Streptococcus thermophilus ATCC 19258 strain.

In a particular embodiment of the method, the prebiotic is an oligosaccharide selected from the group consisting of a fructooligosaccharide, inulin, pectic polysaccharide, a mannan, a beta-glucan, a pentosan, an arabinan, a galactan or their combinations thereof. In a specific embodiment, the prebiotic is an oligosaccharide, preferably, a fructooligosaccharide. In a specific embodiment, the prebiotic is a fructooligosaccharide, present in an amount ranging from 15 to 25 wt %. In a particular embodiment of the method, the proteolytic enzyme is selected from the group consisting of pepsin, trypsin, chymotrypsin, bromelain, an enzyme obtained from a fungal strain or a bacterial strain, preferably Bacillus and an enzyme extracted from the fruits of Ananas comosus. In a specific embodiment, the proteolytic enzyme is obtained from a Bacillus strain, preferably Bacillus subtilis ATCC 11774 strain. In a specific embodiment, the proteolytic enzyme is bromelain extract obtained from the fruits of Ananas comosus. In a further specific embodiment, the proteolytic enzyme is a Bacillus subtilis ATCC 11774 strain comprising bacterial protease whole cell in combination with bromelain extract obtained from the fruits of Ananas comosus. In a still further specific embodiment, the proteolytic enzyme is a bacterial strain obtained from Bacillus subtilis ATCC 11774 strain comprising bacterial protease whole cell in combination with bromelain extract obtained from the fruits of Ananas comosus present in an amount ranging from 15 to 45 wt %.

In a further particular embodiment, (i) a) a therapeutically effective amount of a probiotic comprises 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) a therapeutically effective amount of a prebiotic comprises 100 to 500 mg of fructooligosaccharide; and (ii) a therapeutically effective amount of a proteolytic enzyme comprises 50 to 200 mg of Bacillus subtilis, preferably Bacillus subtilis ATCC 11774 strain comprising bacterial protease whole cell in combination with bromelain extract obtained from the fruits of Ananas comosus having a protease activity of 25,000 to 70,000 HUT.

In a still further particular embodiment, (i) a) a therapeutically effective amount of a probiotic comprises 30 billion counts of cells of probiotic Lactobacillus acidophilus ATCC 4356 strain, 30 billion counts of cells of Bifidobacterium longum ATCC 15707 strain and 30 billion counts of cells of Streptococcus thermophilus ATCC 19258 strain; b) a therapeutically effective amount of a prebiotic comprises 100 to 200 mg of fructooligosaccharide; and (ii) a therapeutically effective amount of a proteolytic enzyme comprises 100 to 200 mg of Bacillus subtilis, preferably Bacillus subtilis ATCC 11774 strain comprising bacterial protease whole cell in combination with bromelain extract obtained from the fruits of Ananas comosus having a protease activity of 35,000 to 70,000 HUT.

In a further particular embodiment, (i) a) a therapeutically effective amount of a probiotic comprises 20 billion counts of cells of Lactobacillus acidophilus ATCC 4356 strain, 20 billion counts of cells of Bifidobacterium longum ATCC 15707 strain and 20 billion counts of cells of Streptococcus thermophilus ATCC 19258 strain; b) a therapeutically effective amount of a prebiotic comprises 100 to 125 mg of fructooligosaccharide; and (ii) a therapeutically effective amount of a proteolytic enzyme comprises 100 to 200 mg of Bacillus subtilis, preferably Bacillus subtilis ATCC 11774 strain comprising bacterial protease whole cell in combination with bromelain extract obtained from the fruits of Ananas comosus having a protease activity of 35,000 to 70,000 HUT.

In a further particular embodiment, (i) a) a therapeutically effective amount of a probiotic comprises 15 billion counts of cells of Lactobacillus acidophilus ATCC 4356 strain, 15 billion counts of cells of Bifidobacterium longum ATCC 15707 strain and 15 billion counts of cells of Streptococcus thermophilus ATCC 19258 strain; b) a therapeutically effective amount of a prebiotic comprises 100 to 125 mg of fructooligosaccharide; and (ii) a therapeutically effective amount of a proteolytic enzyme comprises 100 to 200 mg of Bacillus subtilis, preferably Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, (i) a) a therapeutically effective amount of a probiotic comprises a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain; b) a therapeutically effective amount of a prebiotic comprises 100 to 125 mg of fructooligosaccharide; and (ii) a therapeutically effective amount of a proteolytic enzyme comprises 100 to 200 mg of Bacillus subtilis, preferably Bacillus subtilis ATCC 11774 strain comprising bacterial protease whole cell in combination with bromelain extract obtained from the fruits of Ananas comosus having a protease activity of 35,000 to 70,000 HUT.

In a still further particular embodiment, (i) a) a therapeutically effective amount of a probiotic comprises 5 to 10 billion counts of cells of Lactobacillus acidophilus ATCC 4356 strain, 5 to 10 billion counts of cells of Bifidobacterium longum ATCC 15707 strain and 5 to 7.5 billion counts of cells of Streptococcus thermophilus ATCC 19258 strain; b) a therapeutically effective amount of a prebiotic comprises 100 mg of fructooligosaccharide; and (ii) a therapeutically effective amount of a proteolytic enzyme comprises 75 to 100 mg of Bacillus subtilis, preferably Bacillus subtilis ATCC 11774 strain comprising bacterial protease whole cell in combination with bromelain extract obtained from the fruits of Ananas comosus having a protease activity of 25,000 to 35,000 HUT.

In a still further particular embodiment, (i) a) a therapeutically effective amount of a probiotic comprises a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain; b) a therapeutically effective amount of a prebiotic comprises 100 mg of fructooligosaccharide; and (ii) a therapeutically effective amount of a proteolytic enzyme comprises 75 to 150 mg of Bacillus subtilis, preferably Bacillus subtilis ATCC 11774 strain comprising bacterial protease whole cell in combination with bromelain extract obtained from fruits of Ananas comosus having a protease activity of 26,250 to 52,500 HUT.

In a particular embodiment, the present invention provides an enzobiotic therapeutic combination comprising a therapeutically effective amount of: (i) a synbiotic comprising at least one probiotic and at least one prebiotic; and (ii) at least one proteolytic enzyme for use in the treatment or prophylaxis of renal diseases or disorders.

In a specific embodiment, the present invention provides an enzobiotic therapeutic combination comprising a therapeutically effective amount of: (i) a synbiotic comprising at least one probiotic and at least one prebiotic; and (ii) at least one proteolytic enzyme for use in the treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

In a particular embodiment, the present invention provides an enzobiotic therapeutic combination for use as a therapeutic supplement or a nutritional supplement or a food supplement in renal diseases or disorders, wherein the renal disease or disorder is a stage 1, stage 2, stage 3, stage 4 or stage 5 CKD, end stage renal disease, CKD in subjects suffering from cardiovascular disease, CKD in subjects suffering from SARS-CoV-2 or COVID-19 infection.

The enzobiotic therapeutic combination of the present invention is particularly useful in improving kidney performance and cardiac performance in chronic kidney disease and end stage renal disease.

In an embodiment, the present invention provides an enzobiotic therapeutic composition comprising a therapeutically effective amount of: (i) a synbiotic comprising at least one probiotic and at least one prebiotic; and (ii) at least one proteolytic enzyme for use in the treatment or prophylaxis of renal diseases or disorders.

In a specific embodiment, the present invention provides an enzobiotic therapeutic composition comprising a therapeutically effective amount of: (i) a synbiotic comprising at least one probiotic and at least one prebiotic; and (ii) at least one proteolytic enzyme for use in the treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

In a particular embodiment, the present invention provides an enzobiotic therapeutic composition for use as a therapeutic supplement or a nutritional supplement or a food supplement in renal diseases or disorders, wherein the renal disease or disorder is a stage 1, stage 2, stage 3, stage 4 or stage 5 CKD, end stage renal disease, CKD in subjects suffering from cardiovascular disease, CKD in subjects suffering from SARS-CoV-2 or COVID-19 infection.

In a further embodiment, the present invention relates to the use of an enzobiotic therapeutic combination in the manufacture of a therapeutic supplement or a nutritional supplement or a food supplement for treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

In a still further embodiment, the present invention relates to the use of an enzobiotic therapeutic composition comprising the said enzobiotic combination in the manufacture of a therapeutic supplement or a nutritional supplement or a food supplement for treatment or prophylaxis of renal diseases or disorders, wherein the renal disease or disorder is a stage 1, stage 2, stage 3, stage 4 or stage 5 chronic kidney disease, end stage renal disease, chronic kidney disease in cardiovascular patients and chronic kidney disease in subjects suffering from SARS-CoV-2 or COVID-19 infection.

In a further embodiment of the invention, the therapeutic combination comprising the combination of a synbiotic and a proteolytic enzyme effectively reduces the concentration of nitrogenous wastes in the blood. In a yet further embodiment of the invention, the enzobiotic therapeutic combination and the enzobiotic therapeutic composition comprising the said combination, is effective in reducing the concentration of protein bound serum uremic toxins p-cresol and indoxyl sulphate. The present inventors have found and established through clinical studies that the therapeutic combination and the composition comprising the same, is effective in reducing protein bound serum uremic toxins p-cresol and indoxyl sulphate facilitating extended life, reducing stress to heart so that cardio pulmonary clinical management can be intervened effectively. Further, the clinical and pre-clinical studies suggest that the therapeutic combination of the present invention and the therapeutic composition comprising the same, when given as a therapeutic supplement or a nutritional supplement or a food supplement may help in reducing the production of harmful metabolites generated by undigested protein and alter the gut microbiome favourable in patients with CKD and may improve their survival. The pre-clinical studies clearly establish the effectiveness of the enzobiotic therapeutic combination comprising a synergistic combination of a synbiotic and a proteolytic enzyme in reducing the concentration of nitrogenous wastes in the blood. The clinical studies also establish that the combination and the composition comprising the said composition make gut microbiome favourable, can delay dialysis in CKD patients by reducing uremic toxins p-cresol and indoxyl sulphate to a significant extent, reduce CRP and thrombocytopenia, thereby improving cardiac performance, lipid profile and quality of life in CKD patients. The histopathological examination of the kidney and caecum post administration of the enzobiotic combination of the present invention further reveal marked improvement in kidney parenchyma and health of caecum in gentamycin induced kidney damaged animals, thereby indicating their effectiveness in exhibiting significant nephroprotective effect in CKD patients.

The enzobiotic combination of the present invention and the composition comprising the said combination modulate gut microbiota and enhance absorption of proteins in the small intestine within 90 minutes and potentially intervene formation of protein bound uremic toxins from intestinal microbial metabolism of aromatic amino acids, and promote muscle building and improve muscle recovery. Since inflammation and oxidative stress are evident in the moderate stages of CKD, the key hypothesis that controlling toxin levels can reduce CKD complications and slow CKD progression, the clinical studies of the present invention establish that early intervention, can prevent formation of uremic toxins and benefit quality of life of CKD patients. The administration of the enzobiotic oral capsule reduced the p-cresol levels and this resulted in significant increase in platelet count in CKD patients with cardiovascular disease and thus proved to be effective to improve cardiac performance. The clinical studies further establish that the enzobiotic therapeutic combination and the composition comprising the said combination of the present invention facilitates improved immunity, extended life and better recovery of subjects suffering from CKD in subjects suffering from SARS-CoV-2 or COVID-19 infection. The administration of the enzobiotic oral capsule to CKD patients in subjects suffering from SARS-CoV-2 or COVID-19 infection reduced the indoxyl sulphate levels and this resulted in significant increase in red blood cell (RBC) count in such patients, proving effective in improved recovery of these patients.

In another embodiment, the proteolytic enzyme of the present invention when taken as an adjuvant to the dietary protein supplements augments the protein breakdown process when the endogeneous peptidases are undergoing over processing (i.e. slowing down of endogenous peptidases due to increased protein intake) and helps in quick and effective degradation of proteins to small peptides in the gastrointestinal system of a human being. The bacterial protease enzyme in the enzobiotic therapeutic combination, enzobiotic composition and the enzobiotic kit, when ingested helps in improving the absorption rate of the dietary protein supplement and prevents unnecessary wasting of protein due to deficient digestive process.

In one embodiment, when the probiotic component is a mono culture, the said mono culture constitutes 100% of the probiotic component. When the probiotic component is comprised of at least two or more microorganisms, each of the microorganisms can constitute from 10 to 90% of the probiotic component, wherein the total wt % of all microorganisms is 100%. In particular embodiments, when there are two or more microorganisms, each of the microorganisms can be present in equal amounts. For instance, a probiotic component can be comprised of two microorganisms, wherein each of the microorganisms constitute 50% of the probiotic component. In certain other embodiments, a probiotic component can be comprised of three microorganisms, wherein each of the microorganisms constitute 33.3% of the probiotic component. In particular embodiments, the probiotic component in the enzobiotic combination and the enzobiotic composition of the present invention is comprised of Lactobacillus acidophilus ATCC 4356 strain, Bifidobacterium longum ATCC 15707 strain and Streptococcus thermophilus ATCC 19258 strain in a weight ratio of 1:1:1.

The probiotic components, i.e. each of the microorganisms that are employed as a probiotic component and the microorganisms employed for producing the protease enzyme can be used as such or may be processed, for example, purified, concentrated, lyophilized and stored before addition to the enzobiotic combination or enzobiotic composition for a time and temperature conditions that prevents loss of substantial probiotic and enzymatic activity.

The proteolytic enzyme of the present invention is obtained from a commercially available source. Alternately, the proteolytic enzyme of the present invention can be prepared according to the process steps described below:
(i) The fruits of Ananas comosus are subjected to peeling and preliminary cleaning, followed by cell disruption or crushing mechanically as described in Ravindra Babu et al., Chemical Engineering and Process, 2008; 47:83-89, which is incorporated herein as a reference in its entirety.
(ii) The crushed material is then subjected to centrifugation, ultrafiltration and lyophilization steps as described in Carlos A. Corzo et al., Food Chem., 2012; 133:631-35, which is incorporated herein as a reference in its entirety.
(iii) Further, purification is done using reverse micellar system in order to identify whether the product is thermodynamically stable and attracts protein of interest entrapped in micelles and the impurities are eliminated in the organic phase, as described in Nawaz, A. et al., Braz. Arch. Biol. Technol., 2016; 59 (e16150010):1-16, which is incorporated herein as a reference in its entirety, to yield bromelain.
(iv) Bacillus subtilis whole cell is cultured in nutrient plates and subjected to partial purification using ammonium sulfate, dialysis and Diethylaminoethyl (DEAE) cellulose ion exchange chromatography. Traceability was carried out using squirl flow technology at 80 to 110° C. The method employed gelatine for immobilization, glucose as substrate and peptone to yield B. subtilis protease whole cell with enzymatic activity of 44 to 45.5 μg/ml.
(v) 50.5 to 101 mg of B. subtilis comprising bacterial protease whole cell extract was blended with 49.5 to 100 mg of bromelain extract obtained from the fruits of Ananas comosus to obtain the proteolytic enzyme.

The probiotic microorganisms and the prebiotic of the present invention is obtained from a commercially available source. Alternately, the process of preparation of the synbiotic of the present invention and that of the enzobiotic combination and enzobiotic composition can be carried out according to the process steps provided below:
(i) The synbiotic is prepared by aseptically freeze-drying the probiotic microorganisms (Lactobacillus acidophilus ATCC 4356 strain, Bifidobacterium longum ATCC 15707 strain and Streptococcus thermophilus ATCC 19258 strain) which are mixed in specified amounts as indicated in each of the embodiments described herein above.
(ii) The processed bulk probiotic microorganisms are then combined with the prebiotic component, fructooligosaccharide to produce the synbiotic.
(iii) The synbiotic is then combined with the proteolytic enzyme (comprising B. subtilis ATCC 11774 strain and bromelain extract obtained from fruits of Ananas comosus) in specified amounts as provided in each of the embodiments described herein above to obtain the enzobiotic combination.
(iv) Each of the products can be prepared as a oral tablet or powder or soft gel or liquids or a sachet or an oral capsule according to standard methods known in the art.

In one embodiment, when the prebiotic component is a single non-digestive carbohydrate, the said non-digestive carbohydrate constitutes 100% of the prebiotic component. When the prebiotic component comprises of two or more non-digestive carbohydrates, each non-digestive carbohydrate can comprise 5 to 90% of the prebiotic component, wherein the total wt % of non-digestive carbohydrate is 100%.

In one embodiment, each of the probiotics, prebiotics or proteolyse enzyme can be prepared independently as a separate product and can be orally administered to the subject in need thereof. In one embodiment, each of the probiotics, prebiotics or proteolytic enzyme can be prepared independently as a separate formulation using suitable therapeutically acceptable carriers in the form of oral tablets or oral capsules or sachets or powders etc. and can be orally administered to the subject in need thereof. Each of the probiotics, prebiotics, proteolytic enzymes can be administered simultaneously, sequentially or intermittently such that the therapeutic effects of each of these components are sustained. In one embodiment, at least one probiotic and the proteolytic enzyme are formulated in to a single combination. In one embodiment, at least one probiotic and the proteolytic enzyme along with suitable therapeutically acceptable carriers are formulated as a single formulation in the form of an oral tablet, oral capsule, sachet or powder. In one embodiment, at least one prebiotic and a proteolytic enzyme along with suitable therapeutically acceptable carriers are formulated in to a single formulation in the form of an oral tablet, oral capsule, sachet or powder. In one embodiment, at least one proteolytic enzyme is formulated along with therapeutically acceptable carriers in the form of an oral tablet, oral capsule, sachet of powder. In one embodiment, at least one probiotic, at least one prebiotic and a proteolytic enzyme are formulated in to a single combination. In another embodiment, at least one prebiotic, at least one prebiotic, the proteolytic enzyme and suitable pharmaceutically acceptable carriers are formulated in to a single formulation, in the form of an oral tablet, oral capsule, sachet or powder.

The pharmaceutical compositions according to the present invention are prepared in a manner known and familiar to one skilled in the art. Pharmaceutically acceptable inert inorganic and/or organic carriers and/or additives are used in addition to one or more of the active components comprising: (i) a) synbiotic comprising at least one probiotic and b) at least one prebiotic; (ii) at least one proteolytic enzyme. For the production of pills, tablets, coated tablets and hard gelatin capsules it is possible to use, for example, lactose, corn starch or derivatives thereof, gum arabic, magnesia or glucose, etc. Carriers for soft gelatin capsules and suppositories are, for example, fats, waxes, natural or hardened oils, etc. Suitable carriers for the production of solutions, for example injection solutions, or of emulsions or syrups are, for example, water, physiological sodium chloride solution or alcohols, for example, ethanol, propanol or glycerol, sugar solutions, such as glucose solutions or mannitol solutions, or a mixture of the various solvents which have been mentioned and a buffer to provide a suitably buffered isotonic solution. For understanding the methods of preparing the pharmaceutical compositions and considerations for the inclusion of various components in pharmaceutical compositions, See, Gilman et al. (Eds.) (1990); Goodman and Gilman's: The Pharmacological Basis of Therapeutics, 8th Ed., Pergamon Press, which is incorporated herein as reference in its entirety.

In an embodiment, the present invention provides an enzobiotic therapeutic combination and an enzobiotic therapeutic composition comprising the said combination, wherein, the further therapeutic agent is selected from at least one of a probiotic, a prebiotic, a synbiotic comprising at least one probiotic and a prebiotic, a proteolytic enzyme, a micronutrient selected from a vitamin or a mineral. The probiotic that can be added as a further therapeutic agent in the present invention include, but not limited to, Aerococcus, Aspergillus, Bacillus, Bacteroides, Bifidobacterium, Candida, Clostridium, Debaromyces, Enterococcus, Fusobacterium, Lactobacillus, Lactococcus, Melissococcus, Micrococcus, Mucor, Oenococcus, Pediococcus, Penicillium, Peptostreptococcus, Propionibacterium, Rhizopus, Streptococcus, Torulopsis, Weissella or their combinations thereof. In particular, the probiotic that may be included as a further therapeutical agent is chosen from the list consisting of, but not limited to, at least one of Bacillus strains selected from B. coagulans, B. subtilis and B. laterosporus; at least one of the Bifidobacterium strains selected from B. animalis, B. bifidum, B. longum, B. catenulatum, B. breve, B. animalis; at least one of the Enterococcus strains, preferably E. faecium; at least one of the Lactobacillus strains selected from L. acidophilus, L. brevis, L. bulgaricus, L. casei, L. fermentum, L. helviticus, L. plantarum, L. leichmannii, L. salivarius and L. cellobiosus; at least one of the Pediococcus strains, preferably P. acidilactici, at least one of Propionibacterium strains selected from P. jensenii and P. freudenreichii; at least one of Peptostreptococcus strains selected from P. productus; and at least one of Saccharomyces strains selected from S. boulardii or their combinations thereof. In another particular embodiment, the probiotic as an additional therapeutic agent is selected from at least one of the bacterial strains selected from the group consisting of Bacillus coagulans, Bacillus subtilis, Bifidobacterium longum ATCC 15707 strain, Lactobacillus acidophilus ATCC 4356 strain, Lactobacillus plantarum or Streptococcus thermophilus ATCC 19258 strain or their combinations thereof. In specific embodiments, the probiotic that can be added as a further therapeutic agent is selected from at least one of Bacillus coagulans or Lactobacillus plantarum or their combinations thereof.

The prebiotic that can be added as a further therapeutic agent in the enzobiotic therapeutic combination and the enzobiotic composition is selected from the list of non-digestible carbohydrates, oligosaccharides and polysaccharides and in particular, includes, but not limited to, an oligosaccharide selected from the group consisting of a fructooligosaccharide, inulin, pectic polysaccharide, a mannan, a beta-glucan, a pentosan, an arabinan, a galactan or their combinations thereof. The exemplary prebiotic that can be used as a further therapeutic agent include an oligosaccharide, preferably a fructooligosachharide, a soy fructooligosaccharide, inulin or banana fiber or fructooligosaccharides available in garlic, onion, tomato, wheat, asparagus, artichoke, leek, honey, rye, brown sugar, barley, triticale, beer, lettuce, chicory, burdock, beetroot, apples, bulbs like red lilies, yacon, oats, Chinese chive and Jerusalem artichoke or their combinations thereof.

The protease enzyme that can be added as a further therapeutic agent in the enzobiotic therapeutic combination and the enzobiotic therapeutic composition is selected from at least one of pepsin, trypsin, chymotrypsin, bromelain, a protease enzyme obtained from a fungal or a bacterial source or an enzyme obtained from the fruits or stem of Ananas comosus.

The vitamin that can be added as a further therapeutic agent in the enzobiotic therapeutic combination and the enzobiotic therapeutic composition, include, but not limited to, Vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxam or pyridoxamine or pyridoxine hydrochloride), Vitamin B7 (biotin), Vitamin B9 (folic acid) and Vitamin B12 (cyanocobalamin and cobalamins), Vitamin C (ascorbic acid), Vitamin D, Vitamin E, Vitamin K. The mineral that can be incorporated as a further therapeutic agent in the enzobiotic therapeutic combination and the enzobiotic composition include, but not limited to, macrominerals chosen from calcium, phosphorus, magnesium, sodium, chloride, potassium and sulfur and the trace minerals chosen from iron, manganese, copper, zinc, iodine, fluoride and selenium. In particular embodiments, the vitamin as a further therapeutic agent is selected from Vitamin A, Vitamin C, Vitamin D, Vitamin E and Vitamin K. In a particular embodiment, the mineral that can be added as a further therapeutic agent is selected from calcium, iron, magnesium, selenium, zinc and copper. In a specific embodiment, the further therapeutic agents in the enzobiotic combination and the enzobiotic composition is a vitamin selected from Vitamin A, Vitamin C, Vitamin E and Vitamin K and a mineral, preferably zinc.

In a particular embodiment, the present invention provides a therapeutic combination, wherein, the further therapeutic agent is selected from at least one of a probiotic, a prebiotic or a synbiotic comprising at least one probiotic and a prebiotic, a micronutrient selected from a vitamin and a mineral.

In another particular embodiment, the present invention provides an enzobiotic therapeutic combination, wherein the combination comprises (i) a synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain; b) 15 to 25 wt % of fructooligosaccharide; and (ii) 15 to 45 wt % of Bacillus subtilis ATCC 11774 strain comprising bacterial protease whole cell in combination with bromelain extract obtained from the fruits of Ananas comosus; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a further particular embodiment, the present invention provides an enzobiotic therapeutic combination, wherein the combination comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) 100 to 500 mg of fructosaccharide; and (ii) 50 to 200 mg of Bacillus subtilis ATCC 11774 strain comprising bacterial protease whole cell in combination with bromelain extract obtained from the fruits of Ananas comosus having a protease activity of 25,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 30 billion counts of cells of probiotic Lactobacillus acidophilus ATCC 4356 strain, 30 billion counts of cells of Bifidobacterium longum ATCC 15707 strain and 30 billion counts of cells of Streptococcus thermophilus ATCC 19258 strain; b) 100 to 200 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 20 billion counts of cells of probiotic Lactobacillus acidophilus ATCC 4356 strain, 20 billion counts of cells of Bifidobacterium longum ATCC 15707 strain and 20 billion counts of cells of Streptococcus thermophilus ATCC 19258 strain; b) 100 to 125 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 15 billion counts of cells of Lactobacillus acidophilus ATCC 4356 strain, 15 billion counts of cells of Bifidobacterium longum ATCC 15707 strain and 15 billion counts of cells of Streptococcus thermophilus ATCC 19258 strain; b) 100 to 125 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain; b) 100 to 125 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 5 to 10 billion counts of cells of Lactobacillus acidophilus ATCC 4356 strain, 5 to 10 billion counts of cells of Bifidobacterium longum ATCC 15707 strain and 5 to 7.5 billion counts of cells of Streptococcus thermophilus ATCC 19258 strain; b) 100 mg of fructooligosaccharide; (ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a still further particular embodiment, the present invention provides an enzobiotic therapeutic combination, wherein the combination comprises (i) a synbiotic comprising a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain; b) 100 mg of fructooligosaccharide; (ii) 75 to 150 mg of Bacillus subtilis ATCC 11774 strain comprising bacterial protease whole cell in combination with bromelain extract obtained from the fruits of Ananas comosus having a protease activity of 26,250 to 52,500 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In a particular embodiment, the present invention provides an enzobiotic therapeutic combination, wherein the combination comprises (i) a synbiotic comprising a) 3 to 4 billion counts of cells of Lactobacillus acidophilus ATCC 4356 strain, 3 to 5 billion counts of cells of Lactobacillus plantarum strain, 3 to 5 billion counts of cells of Bifidobacterium longum ATCC 15707 strain, 3 to 5 billion counts of cells of Streptococcus thermophilus ATCC 19258 strain and 3 to 4 billion counts of cells of Bacillus coagulans strain; b) 100 to 200 mg of fructooligosaccharide; (ii) 75 to 100 mg of Bacillus subtilis, preferably Bacillus subtilis ATCC 11774 strain comprising bacterial protease whole cell in combination with bromelain extract obtained from the fruits of Ananas comosus having a protease activity of 25,000 to 35,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc.

In another particular embodiment, the present invention provides an enzobiotic therapeutic composition, wherein the composition comprises (i) a synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain; b) 15 to 25 wt % of fructooligosaccharide; (ii) 15 to 45 wt % of Bacillus subtilis ATCC 11774 strain comprising bacterial protease whole cell in combination with bromelain extract obtained from the fruits of Ananas comosus having a protease activity of 25,000 to 70,000 HUT; and (iii) a) at least one vitamin chosen from 5000 to 10,000 iu of Vitamin A, 400 to 700 mg of Vitamin C, 400 to 800 iu of Vitamin E and 100 to 125 μg of Vitamin K; b) 3.5 to 12 mg of zinc; and (iv) filler, preferably selected from microcrystalline cellulose, maltodextrin and sucralose, 1 to 5 wt % of magnesium stearate as an anticaking agent and 1 to 2 wt % of talc as a free flowing agent; wherein each of the probiotics, the prebiotic and the proteolytic enzyme formulated along with the filler together comprise 90 to 95 wt % of the composition.

In a further particular embodiment, the present invention provides an enzobiotic therapeutic composition, wherein the composition comprises (i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain; b) 100 to 500 mg of fructosaccharide; and (ii) 50 to 200 mg of Bacillus subtilis ATCC 11774 strain comprising bacterial protease whole cell in combination with bromelain extract obtained from the fruits of Ananas comosus having a protease activity of 25,000 to 70,000 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc; and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the composition comprises (i) a synbiotic comprising a) 30 billion counts of cells of probiotic Lactobacillus acidophilus ATCC 4356 strain, 30 billion counts of cells of Bifidobacterium longum ATCC 15707 strain and 30 billion counts of cells of Streptococcus thermophilus ATCC 19258 strain; b) 100 to 200 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the composition comprises (i) a synbiotic comprising a) 20 billion counts of cells of probiotic Lactobacillus acidophilus ATCC 4356 strain, 20 billion counts of cells of Bifidobacterium longum ATCC 15707 strain and 20 billion counts of cells of Streptococcus thermophilus ATCC 19258 strain; b) 100 to 125 mg of fructooligosaccharide; (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the combination comprises (i) a synbiotic comprising a) 15 billion counts of cells of Lactobacillus acidophilus ATCC 4356 strain, 15 billion counts of cells of Bifidobacterium longum ATCC 15707 strain and 15 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; and (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the composition comprises (i) a synbiotic comprising a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain; b) 100 to 125 mg of fructooligosaccharide; and (ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc; and (iv) filler, preferably selected from microcrystalline cellulose, maltodextrin and sucralose, 1 to 5 wt % of magnesium stearate and 1 to 5 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the composition comprises (i) a synbiotic comprising a) 5 to 10 billion counts of cells of Lactobacillus acidophilus strain, 5 to 10 billion counts of cells of Bifidobacterium longum ATCC 15707 strain and 5 to 7.5 billion counts of cells of Streptococcus thermophilus ATCC 19258 strain; b) 100 mg of fructooligosaccharide; and (ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT; iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

In a still further particular embodiment, the present invention provides an enzobiotic therapeutic composition, wherein the composition comprises (i) a synbiotic comprising a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain; b) 100 mg of fructooligosaccharide; and (ii) 75 to 150 mg of Bacillus subtilis ATCC 11774 strain comprising bacterial protease whole cell in combination with bromelain extract obtained from the fruits of Ananas comosus having a protease activity of 26,250 to 52,500 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc; and (iv) filler, preferably selected from microcrystalline cellulose, maltodextrin and sucralose, 1 to 5 wt % of magnesium stearate and 1 to 5 wt % of talc; wherein each of the probiotics, the prebiotic and the proteolytic enzyme formulated along with the filler together comprise 90 to 95 wt % of the composition.

In a particular embodiment, the present invention provides an enzobiotic therapeutic composition, wherein the composition comprises (i) a synbiotic comprising a) 3 to 4 billion counts of cells of Lactobacillus acidophilus ATCC strain, 3 to 5 billion counts of cells of Lactobacillus plantarum strain, 3 to 5 billion counts of cells of Bifidobacterium longum ATCC 15707 strain, 3 to 5 billion counts of cells of Streptococcus thermophilus ATCC 19258 strain and 3 to 4 billion counts of cells of Bacillus coagulans strain; b) 100 mg of fructooligosaccharide; (ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT; (iii) a) at least one vitamin chosen from, preferably 5000 to 10,000 iu of Vitamin A, 400 to 700 mg of Vitamin C, 400 to 800 iu of Vitamin E and 100 to 125 μg of Vitamin K; b) 3.5 to 12 mg of zinc; and (iv) filler, preferably selected from microcrystalline cellulose, maltodextrin and sucralose, 1 to 5 wt % of magnesium stearate and 1 to 2 wt % of talc; wherein each of the probiotics, the prebiotic and the proteolytic enzyme formulated along with the filler together comprise 90 to 95 wt % of the composition.

The enzobiotic therapeutic compositions according to the present invention can be administered orally, for example in the form of pills, tablets, coated tablets, capsules, granules or elixirs. Administration, however, can also be carried out rectally, for example in the form of suppositories, or parenterally, for example intravenously, intramuscularly or subcutaneously, in the form of injectable sterile solutions or suspensions, or topically, for example in the form of solutions or transdermal patches, or in other ways, for example in the form of aerosols or nasal sprays. The enzobiotic therapeutic composition of the present invention for administration are prepared in the form of tablets, capsules, pills, powders, granules, suppositories, sterile parenteral solutions or suspensions, sterile non-parenteral solutions, suspensions, oral solutions, oral suspensions and the like containing effective amounts of the active components.

In accordance with one embodiment, the enzobiotic therapeutic composition may be administered in solid or liquid oral dosage form such as oral tablets, chewable tablets, oral capsules, pills, granules, emulsions, sachets, suspensions, syrups, elixirs, granules and suppository. In accordance with another embodiment, the enzobiotic therapeutic composition may be prepared in the form of granules, powdered supplements, reconstitutable powders (spray dried, dry mixed or agglomerated) and the like. However, any other solid, liquid or semi-solid enzobiotic composition or a formulation, as known to or appreciated in the art, can be formulated to serve its intended purpose, as laid out in the present disclosure, without departing from the scope and spirit of the present invention.

The enzobiotic composition of the present invention can be formulated as an immediate-release formulation, extended-release formulation, modified-release formulation or a pulse-release formulation. The amount of the active ingredients, the synbiotic comprising therapeutically effective amounts of at least one probiotic and prebiotic and the proteolytic enzyme, in the enzobiotic therapeutic combination and the enzobiotic therapeutic composition of the present invention can, vary depending on whether it is a daily dosage or a single dose of the composition.

In a specific embodiment, the present invention provides an enzobiotic therapeutic combination, wherein the combination comprises:
(i) a) 30 to 45 billion counts of cells of Lactobacillus acidophilus ATCC 4356 strain, 30 to 60 billion counts of cells of Bifidobacterium longum ATCC 15707 strain and 15 to 30 billion counts of cells of Streptococcus thermophilus ATCC 19258 strain; b) 100 to 400 mg of fructooligosaccharide per daily dose;
(ii) 151.5 to 303 mg of Bacillus subtilis ATCC 11774 strain comprising bacterial protease whole cell and 140.5 to 300 mg of bromelain extract obtained from the fruits of Ananas comosus per daily dose of the combination.

In a specific embodiment, the present invention provides an zxcv gfcdxzyuikol.;/enzobiotic therapeutic combination, wherein the combination comprises:
(i) a) 10 to 15 billion counts of cells of Lactobacillus acidophilus ATCC 4356 strain, 15 to 30 billion counts of cells of Bifidobacterium longum ATCC 15707 strain and 5 to 15 billion counts of cells of Streptococcus thermophilus ATCC 19258 strain per single dose;
   b) 100 to 125 mg of fructooligosaccharide per single dose;
(ii) 50.5 to 101 mg of Bacillus subtilis ATCC 11774 strain comprising bacterial protease whole cell and 49.5 to 100 mg of bromelain extract obtained from the fruits of Ananas comosus per single dose of the combination.

In a specific embodiment, the present invention provides an enzobiotic therapeutic composition, wherein the composition comprises:
(i) a) 30 to 45 billion counts of cells of Lactobacillus acidophilus ATCC 4356 strain, 30 to 60 billion counts of cells of Bifidobacterium longum ATCC 15707 strain and 15 to 30 billion counts of cells of Streptococcus thermophilus ATCC 19258 strain; b) 100 to 400 mg of fructooligosaccharide per daily dose;
(ii) 151.5 to 303 mg of Bacillus subtilis ATCC 11774 strain comprising bacterial protease whole cell and 140.5 to 300 mg of bromelain extract obtained from the fruits of Ananas comosus per daily dose of the composition.

In a specific embodiment, the present invention provides an enzobiotic therapeutic composition, wherein the composition comprises:
(i) a) 10 to 15 billion counts of cells of Lactobacillus acidophilus ATCC 4356 strain, 15 to 30 billion counts of cells of Bifidobacterium longum ATCC 15707 strain and 5 to 15 billion counts of cells of Streptococcus thermophilus ATCC 19258 strain per single dose;
   b) 100 to 125 mg of fructooligosaccharide per single dose;
(ii) 50.5 to 101 mg of Bacillus subtilis ATCC 11774 strain comprising bacterial protease whole cell and 49.5 to 100 mg of bromelain extract obtained from the fruits of Ananas comosus per single dose of the composition.

The daily dosage to be administered is selected to achieve the desired therapeutic effect in subjects being treated for CKD, and in particular, CKD, ESRD, CKD with CVD and CKD in subjects suffering from SARS-CoV-2 or COVID-19 infection. A dosage of about 1000 to 1650 mg/day of the enzobiotic therapeutic combination or the enzobiotic therapeutic composition thereof may be administered per day for 3 to 6 months. If required, higher or lower daily dosages can also be administered.

In a specific embodiment, the present invention provides an enzobiotic therapeutic combination, wherein the combination comprises:
(i) a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain per single dose;
   b) 100 to 125 mg of fructooligosaccharide per single dose;
(ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT per single dose of the combination and administered three doses per day.

In a specific embodiment, the present invention provides an enzobiotic therapeutic combination, wherein the combination comprises:
(i) a) 5 to 10 billion counts of cells of Lactobacillus acidophilus ATCC 4356 strain; 5 to 10 billion counts of cells of Bifidobacterium longum ATCC 15707 strain; 5 to 7.5 billion counts of cells of Streptococcus thermophilus ATCC 19258 per single dose;
   b) 100 mg of fructooligosaccharide per single dose;
(ii) 75 to 100 mg of Bacillus subtilis ATCC 11774 strain comprising whole protease cell in combination with bromelain extract obtained from the fruits of Ananas comosus having a protease activity of 25,000 to 35,000 HUT per single dose of the combination and administered three doses per day.

In a specific embodiment, the present invention provides an enzobiotic therapeutic combination, wherein the combination comprises:
(i) a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain per single dose;
   b) 100 mg of fructooligosaccharide per single dose;
(ii) 75 to 150 mg of Bacillus subtilis ATCC 11774 strain comprising bacterial protease whole cell in combination with bromelain extract obtained from the fruits of Ananas comosus having a protease activity of 26,250 to 52,500 HUT per single dose of the combination and administered three doses per day.

In a specific embodiment, the present invention provides an enzobiotic therapeutic composition, wherein the composition comprises:
(i) a) 12.5 to 20 billion counts of cells of Lactobacillus acidophilus ATCC 4356 strain, 12.5 to 20 billion counts of cells of Bifidobacterium longum ATCC 15707 strain and 5 to 10 billion counts of cells of Streptococcus thermophilus ATCC 19258 strain per single dose;
   b) 100 to 125 mg of fructooligosaccharide per single dose;
(ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT per single dose of the composition and administered three doses per day.

In a specific embodiment, the present invention provides an enzobiotic therapeutic composition, wherein the composition comprises:
(i) a) 5 to 10 billion counts of cells of Lactobacillus acidophilus ATCC 4356 strain; 5 to 10 billion counts of cells of Bifidobacterium longum ATCC 15707 strain; 5 to 7.5 billion counts of cells of probiotic Streptococcus thermophilus ATCC 19258 per single dose;
   b) 100 mg of fructooligosaccharide per single dose;
(ii) 75 to 100 mg of Bacillus subtilis ATCC 11774 strain comprising whole protease cell in combination with bromelain extract obtained from the fruits of Ananas comosus having a protease activity of 25,000 to 35,000 HUT per single dose of the composition and administered three doses per day.

In a specific embodiment, the present invention provides an enzobiotic therapeutic composition, wherein the composition comprises:
(i) a) 12.5 billion counts of cells of Lactobacillus acidophilus ATCC 4356 strain, 12.5 billion counts of cells of Bifidobacterium longum ATCC 15707 strain and 5 billion counts of cells of Streptococcus thermophilus ATCC 19258 strain per single dose;
   b) 100 mg of fructooligosaccharide per single dose;
(ii) 75 to 150 mg of Bacillus subtilis ATCC 11774 strain comprising bacterial protease whole cell in combination with bromelain extract obtained from the fruits of Ananas comosus having a protease activity of 26,250 to 52,500 HUT per single dose of the composition and administered three doses per day.

Actual dosage levels of the active ingredients in the therapeutic combination and the composition of this present invention can be varied so as to obtain an amount of the active ingredient, which is effective to achieve the desired therapeutic response for a particular patient, composition, and mode of administration without being toxic to the patient. The selected dosage level can be readily determined by a skilled medical practitioner in the light of the relevant circumstances, including the condition (renal diseases or disorder) to be treated, the chosen route of administration depending on a number of factors, such as age, weight and physical health and response of the individual patient, pharmacokinetics, severity of the disease and the like, factors known in the medical art.

### EXPERIMENTAL

The abbreviations and terms that are used herein:

LIST OF ABBREVIATIONS

| | | | |
|---|---|---|---|
| BUN | Blood Urea | MCC | Microcrystalline |
| | Nitrogen | | cellulose |
| DEAE | Diethylaminoethyl | NBF | Neutral Buffered |
| cellulose | cellulose | | Formalin |
| H & E | Hemotoxylin and | SGOT | Serum Glutamic- |
| | Eosin | | Oxalocetic |
| | | | Transaminase |
| HPMC | Hydroxy propyl | SGPT | Serum Glutamic- |
| | methyl cellulose | | Pyruvic |
| | | | Transaminase |
| dL | Decilitre | kg | Kilogram |
| g | Gram | ml | Millilitre |
| HUT | Hemoglobin Unit | μg | Microgram |
| | Tyrosine | | |
| H | Hour(s) | mg | milligram |
| mEq/L | Milliequivalence | μ | Microns |
| | per Litre | | |

| | |
|---|---|
| SLE | Systemic Lupus Erythematosus |
| RH | Relative Humidity |
| RT | Room temperature (20° C.-25° C.) |
| RBC | Red Blood Cells |
| 12-12 h dark | 8.00-20.00 h light: 8.00-20.00 h dark |
| light cycle | |

### Example 1

### Enzobiotic Combination

A representative enzobiotic therapeutic combination of the present invention is formulated and details presented in Table 1.

TABLE 1
Enzobiotic therapeutic combination of the present invention

| | | | | | Protease |
|---|---|---|---|---|---|
| | | | | | enzyme |
| | | | | | powder |
| | Lactobacillus | Bifidobacterium | Streptococcus | | (mg) and |
| | Acidophilus | longum | Thermophilus | Fructo | protease |
| Test | ATCC 4356 | ATCC 15707 | ATCC 19258 | oligosaccharide | activity |
| substance | strain (mg) | strain (mg) | strain (mg) | (mg) | (HUT) |
| Synbiotic A | 400 | 400 | 100 | 100 | — |
| Proteolytic | — | — | — | — | 75 mg |
| Enzyme B | | | | | having a |
| | | | | | protease |
| | | | | | activity of |
| | | | | | 26,250 |
| | | | | | HUT |
| Enzobiotic | 400 | 400 | 100 | 100 | 75 mg |
| combination C | | | | | having a |
| | | | | | protease |
| | | | | | activity of |
| | | | | | 26,250 |
| | | | | | HUT |

Each of the above referenced products were prepared, stored under less than RT, administered in three divided doses and tested in animal studies.

As indicated herein above, the synbiotic A comprises the combination of specific probiotics and prebiotic in specified amounts as provided in Table 1. The Proteolytic Enzyme B is a blend of a protease enzyme extracted from Bacillus subtilis ATCC 11774 strain and bromelain extract obtained from the fruits of Ananas comosus present in amounts as provided in Table 1. The probiotic microorganisms contained in Synbiotic A were obtained from Dupont, United States of America (USA) and the Protease Enzyme powder B was obtained from Deerland Enzymes Inc., USA. The enzobiotic combination C comprises synbiotic A and Proteolytic Enzyme B in specified amounts as provided in Table 1.

### Preparation of Proteolytic Enzyme Powder B

The proteolytic enzyme of the present invention can be obtained from the commercially available source/s as indicated herein above or alternately, prepared according to the process steps described below:
(i) The fruits of Ananas comosus were subjected to peeling and preliminary cleaning, followed by cell disruption or crushing mechanically as described in Ravindra Babu et al., Chemical Engineering and Process, 2008; 47:83-89.
(ii) The crushed material was then subjected to centrifugation, ultrafiltration and lyophilization steps as described in Carlos A. Corzo et al., Food Chem., 2012; 133:631-35.
(iii) Further, purification was done using reverse micellar system in order to identify whether the product is thermodynamically stable and attracts protein of interest entrapped in micelles and the impurities are eliminated in the organic phase to yield bromelain, as described in Nawaz, A. et al., Braz. Arch. Biol. Technol., 2016; 59 (e16150010): 1-16.
(iv) Bacillus subtilis whole cell was cultured in nutrient plates and subjected to partial purification using ammonium sulfate, dialysis and DEAE cellulose ion exchange chromatography. Traceability was carried out using squirl flow technology at 80 to 110° C. The method employed gelatine for immobilization, glucose as substrate and peptone to yield B. subtilis protease whole cell with enzymatic activity of 44 to 45.5 μg/ml.
(v) 50.5 to 101 mg of B. subtilis ATCC 11774 strain comprising bacterial protease whole cell extract was blended with 49.5 to 100 mg of bromelain extract obtained from Ananas comosus fruit extract to obtain the proteolytic enzyme powder B.

### Preparation of Synbiotic a and Enzobiotic Combination C

Synbiotic A can be prepared according to the process step (i) described below and the enzobiotic combination C of the present invention prepared according to the process steps (i) to (iii) described below:
(i) The synbiotic was prepared by aseptically freeze-drying the probiotic microorganisms (Lactobacillus acidophilus ATCC 4356 strain, Bifidobacterium longum ATCC 15707 strain and Streptococcus thermophilus ATCC 19258 strain) and mixed in specified amounts as indicated in Table 1.
(ii) The processed bulk probiotic microorganisms were then combined with the prebiotic component, fructooligosaccharide to produce the synbiotic A.
(iii) The synbiotic was then combined with the proteolytic enzyme powder B (comprising B. subtilis and Ananas comosus) in specified amounts as provided in Table 1 to obtain the enzobiotic combination C.

### Example 2—Animal Studies for Enzobiotic Combination

### Objective of the Study:

To study the efficacy of the enzobiotic combination C, synbiotic A and Proteolytic enzyme B in kidney damaged rats. Gentamycin at a dose of 150 mg/kg was administered for 5 consecutive days to induce kidney damage in the rats. The enzobiotic combination C, synbiotic A and Proteolytic enzyme B (prepared in Example 1 and specified amounts provided in Table 1 hereinabove) are administered in three divided doses and tested for animal studies. The efficacy of the enzobiotic combination C was evaluated vis-à-vis synbiotic A and proteolytic enzyme B in kidney damaged rats by measuring body weight, BUN and serum creatinine levels. The histopathological examination was also carried out in each case.

### Grouping of Animals and Experimental Procedure:

### Animals Used in the Study:

The study was conducted on a total of 72 Sprague Dawley male and female rats obtained from the animal house of In vivo Biosciences Inc., and animal food was obtained from the manufacturer, Edvigo (Madison, USA). The animals were maintained as per the Committee for the Purpose of Control and Supervision of Experiments on Animals (CPCSEA) guidelines and internal guidelines of In vivo Biosciences Inc. The animals were housed two per cage under standard laboratory conditions at a temperature (RT) with 12-12 h dark light cycle at a of 64 to 67%. Animals were fed with standard food and water ad libidum. The renal damage was induced to animals using commercially available gentamycin sulphate.

### Experimental Design

The experimental rats were randomized and divided into six groups of 12 animals each. The animal groupings with dosage specifications are provided below in Table 2. “Both” in the table indicates both male and female rats.

TABLE 2
Animal groupings and their treatment regimen

| Animal | | | Number of | |
|---|---|---|---|---|
| groups | Treatment group | Test substance administered | animals | Sex |
| 1. | Treatment group 1 - | No Gentamycin or no test substance/product | 12 | Both |
| | Control | administered; dosed with water | | |
| 2. | Treatment group 2 - | Only Enzobiotic combination C of the present | 12 | Both |
| | Positive Control | invention at 1075 mg/day in three divided | | |
| | | doses | | |
| 3. | Treatment group 3 - | Only Proteolytic Enzyme B of the present | 12 | Both |
| | Positive Control | invention at a dose of 75 mg/day having a | | |
| | | protease activity of 26,250 HUT in three | | |
| | | divided doses | | |
| 4. | Treatment group 4 | Only Gentamycin at a dose of 150 mg/kg body | 12 | Both |
| | Negative Control | weight | | |
| 5a. | Treatment group 5a | Gentamycin at a dose of 150 mg/kg body | 6 | Males |
| | | weight followed by Synbiotic A of the present | | |
| | | invention at a dose of 1000 mg/day in three | | |
| | | divided doses | | |
| 5b. | Treatment group 5b | Gentamycin at a dose of 150 mg/kg body | 6 | Females |
| | | weight followed by Synbiotic A of the present | | |
| | | invention at a dose of 1000 mg/day in three | | |
| | | divided doses | | |
| 6a. | Treatment group 6a | Gentamycin at a dose of 150 mg/kg body | 6 | Males |
| | | weight followed by Proteolytic Enzyme B of | | |
| | | the present invention at a dose of 75 mg/day | | |
| | | having a protease activity of 26,250 HUT in | | |
| | | three divided doses | | |
| 6b. | Treatment group 6b | Gentamycin at a dose of 150 mg/kg body | 6 | Females |
| | | weight followed by Proteolytic Enzyme B of | | |
| | | the present invention at a dose of 75 mg/day | | |
| | | having a protease activity of 26,250 HUT in | | |
| | | three divided doses | | |
| 7a. | Treatment group 7a | Gentamycin at a dose of 150 mg/kg body | 6 | Males |
| | | weight followed by Enzobiotic combination C | | |
| | | of the present invention at a dose of 1075 | | |
| | | mg/day in three divided doses | | |
| 7b. | Treatment group 7b | Gentamycin at a dose of 150 mg/kg body | 6 | Females |
| | | weight followed by Enzobiotic combination C | | |
| | | of the present invention at a dose of 1075 | | |
| | | mg/day in three divided doses | | |

### Preparation of the Test Substance

Distilled water was used as a control. All the test substances were dissolved in distilled water and administered orally to the rats for 28 days. The test substances were administered at a volume of 10 ml/kg and each of the test substances were prepared everyday for the same day dosing. The body weights and food consumption were recorded every three days and at weekly intervals respectively. Blood samples from the rats fed with test substances were collected from each group on day 29 prior to the sacrifice of the animals after overnight fasting. All the animals were subjected to a detailed necropsy on day 29. Kidney and caecum were collected and preserved in 10% NBF from all rats for histopathological examination. The negative control group (treatment group 4), wherein gentamycin was administered to the animals at a dose of 150 mg/kg for 5 consecutive days led to kidney injury or damage in both male and female rats.

### Statistical Analysis

All data were evaluated statistically using Graph pad Prizm. For intergroup comparison, one-way ANOVA followed by Dunnett's post-hoc test analysis of standard or the control vis-à-vis the treatment groups were carried out. Parameters such as body weight and clinical chemistry were evaluated statistically. A P value ≤0.05 was considered statistically significant.

### (i) Body Weight

The individual body weights were measured after first day of treatment and after every three days.

TABLE 3
Effect on mean body weights post treatment

| | | Body weight in grams | | | | | |
|---|---|---|---|---|---|---|---|
| Treatment | | Day | Day | Day | Day | Day | Day |
| Group | Sex | 0 | 12 | 18 | 24 | 30 | 33 |
| Treatment | Males | 170 | 219 | 246 | 258 | 279 | 278 |
| group 1 | Females | 170 | 171 | 193 | 207 | 212 | 210 |
| Treatment | Males | 143 | 157 | 193 | 212 | 239 | 249 |
| group 2 | Females | 134 | 144 | 167 | 178 | 192 | 195 |
| Treatment | Males | 190 | 199 | 236 | 243 | 274 | 282 |
| group 3 | Females | 144 | 154 | 176 | 188 | 203 | 207 |
| Treatment | Males | 127 | 158 | 191 | 214 | 243 | 256 |
| group 4 | Females | 121 | 136 | 157 | 164 | 184 | 189 |
| Treatment | Males | 166 | 192 | 229 | 246 | 275 | 288 |
| group 5a | | | | | | | |
| Treatment | Females | 124 | 148 | 168 | 184 | 198 | 204 |
| group 5b | | | | | | | |
| Treatment | Males | 113 | 144 | 176 | 210 | 239 | 246 |
| group 6a | | | | | | | |
| Treatment | Females | 118 | 137 | 153 | 165 | 184 | 186 |
| group 6b | | | | | | | |
| Treatment | Males | 133 | 152 | 173 | 208 | 241 | 250 |
| group 7a | | | | | | | |
| Treatment | Females | 118 | 145 | 156 | 172 | 190 | 195 |
| group 7b | | | | | | | |

Conclusion: The increase in mean body weights of the treatment groups 5a, 5b, 6a, 6b, 7a and 7b indicate that there is not much deviation of increase in mean body weights in both male rats and female rats as compared to those in the Control groups.

### (ii) Food Intake

TABLE 4
Effect on average food intake post treatment

| | | Week 1 | Week 2 | Week 3 | Week 4 |
|---|---|---|---|---|---|
| Treatment group | Sex | (grams) | (grams) | (grams) | (grams) |
| Treatment group 1 | Males | 19.8 | 20.4 | 19.2 | 18.4 |
| | Females | 19.5 | 20.5 | 18.9 | 22.5 |
| Treatment group 2 | Males | 20.6 | 22.2 | 22.2 | 16.8 |
| | Females | 20.1 | 19.6 | 22.6 | 23.8 |
| Treatment group 3 | Males | 19.8 | 22.3 | 23.4 | 22.3 |
| | Females | 18.8 | 22.5 | 24.6 | 21.6 |
| Treatment group 4 | Males | 21.3 | 19.6 | 22 | 19.6 |
| | Females | 20.6 | 20.6 | 22.3 | 20.8 |
| Treatment group 5a | Males | 17.5 | 22.8 | 18.6 | 21.4 |
| Treatment group 5b | Females | 19.6 | 19.8 | 21.8 | 19.8 |
| Treatment group 6a | Males | 20.6 | 23.1 | 19.6 | 22.8 |
| Treatment group 6b | Females | 18.9 | 21.3 | 20.6 | 18.6 |
| Treatment group 7a | Males | 17.8 | 20.5 | 20.5 | 19.6 |
| Treatment group 7b | Females | 20.6 | 22.5 | 21.8 | 20.8 |

Conclusion: The average food intake of the treatment groups 5a, 5b, 6a, 6b, 7a and 7b indicate that there is not much deviation food intake in both male rats and female rats as compared to those in the control groups.

(iii) BUN, Serum Creatinine and Protein Levels

All the Renal Function test parameters were analysed through Biochemical Analyser, Merck USA according to the standard protocol and CPCSEA GUIDELINES. Renal parameters, BUN, serum creatinine and protein levels were evaluated for all the animal groups.

TABLE 5
Effect of enzobiotic combination C on BUN,
Serum Creatinine and Protein levels

| | | | Serum | Protein |
|---|---|---|---|---|
| | | BUN | Creatinine | Levels |
| Treatment group | Sex | (mg/dL) | (mg/dL) | (g/dL) |
| Treatment group 1 | Males | 25.4 ± 6.9 | 0.9 ± 0.4 | 6.7 ± 3.5 |
| | Females | 27.2 ± 4.2 | 0.9 ± 0.3 | 7.7 ± 2.2 |
| Treatment group 2 | Males | 24.9 ± 5.4 | 0.9 ± 0.3 | 7.6 ± 0.9 |
| | Females | 24.9 ± 5.4 | 0.9 ± 0.3 | 7.6 ± 0.9 |
| Treatment group 3 | Males | 23.6 ± 2.8 | 0.8 ± 0.2 | 6.5 ± 2.2 |
| | Females | 25.3 ± 9.2 | 0.9 ± 0.2 | 7.2 ± 1.4 |
| Treatment group 4 | Males | 38.7 ± 4.9 | 2.1 ± 0.7 | 4.9 ± 0.9 |
| | Females | 36.2 ± 10.1 | 2.4 ± 1.2 | 5.2 ± 1.7 |
| Treatment group 5a | Males | 36.4 ± 4.0 | 2.5 ± 0.9 | 5.2 ± 1.5 |
| Treatment group 5b | Females | 38.2 ± 5.1 | 3.0 ± 0.8 | 4.9 ± 1.5 |
| Treatment group 6a | Males | 30.4 ± 3.2 | 1.4 ± 0.7 | 5.9 ± 2.1 |
| Treatment group 6b | Females | 30.9 ± 6.2 | 1.5 ± 1.1 | 5.5 ± 1.3 |
| Treatment group 7a | Males | 21.0 ± 5.2 | 0.9 ± 0.4 | 6.4 ± 0.8 |
| Treatment group 7b | Females | 26.1 ± 5.4 | 0.8 ± 0.2 | 6.7 ± 1.0 |

### Results:

The biochemical uremic markers, BUN, serum creatinine and protein levels were measured at the end of 28 days. The positive control group, i.e. treatment group 2, wherein animals were administered only with enzobiotic combination C and the positive control group i.e. treatment group 3, wherein the animals were administered with only proteolytic enzyme B, did not show any changes in BUN, serum creatinine levels and protein levels in both male and female rats. The negative control group, wherein gentamycin was administered to the animals at a dose of 150 mg/kg for 5 consecutive days led to kidney injury or damage resulting in the increase of BUN and creatinine levels and decrease in protein in serum in both male and female rats.

The treatment group 7a and 7b, wherein the animals were given enzobiotic combination C in animals with gentamycin induced kidney damage, showed a statistically significant decrease in BUN and creatinine levels and increase in protein levels as compared to treatment group 4, indicating the efficacy of the enzobiotic combination in treating the renal damage. The values as comparable to the normal control rats suggesting a marked improvement in BUN, creatinine and protein levels achieved by the enzobiotic combination C.

The treatment group 6a and 6b, wherein the animals were given proteolytic enzyme B in animals with gentamycin induced renal damage, showed moderate decrease in BUN and creatinine levels and moderate increase in protein levels, while the treatment group 5a and 5b, wherein the animals were administered synbiotic A in animals with gentamycin induced renal damage, did not show any significant changes in BUN, creatinine and protein levels.

### Conclusion:

The results indicate the effectiveness and synergistic or combinative effect of the enzobiotic combination C (comprising synbiotic A and proteolytic enzyme B) in showing significant decrease in BUN, creatinine levels and significant increase in protein levels in gentamycin induced kidney damaged animals vis-à-vis the individual effects of administering synbiotic A or proteolytic enzyme B in gentamycin induced kidney damaged animals.

The results further indicate the effectiveness of the enzobiotic therapeutic combination of the present invention in reducing the nitrogenous wastes in patients with high amount of nitrogenous wastes and the effectiveness of the enzobiotic combination in improving the quality of life, increasing life span and also in treating renal failure.

### (iv) General Clinical Signs and Mortality

Clinical signs and mortality were observed once daily during the course of observation period. Detailed clinical examinations were carried out for the following signs: changes in skin, fur, eyes, mucous membranes, unusual respiratory pattern, lacrimation, pupil size, piloerection, gait and response to handling (hand-held observations).

### Conclusion:

The general clinical signs and mortality was observed and there were no clinical signs of mortality in any of the tested groups.

### (v) Clinical Parameters:

The clinical parameters like calcium levels and sodium levels were also evaluated for all the animal groups as presented in Table 6.

TABLE 6
Evaluation of clinical parameters:
Sodium levels and Calcium levels

| | | Sodium | Calcium |
|---|---|---|---|
| Treatment group | Sex | (mEq/L) | (mEq/L) |
| Treatment group 1 | Males | 142.0 ± 4.9 | 11.5 ± 3.5 |
| | Females | 140.7 ± 10.2 | 11.6 ± 2.9 |
| Treatment group 2 | Males | 146.7 ± 18.8 | 11.9 ± 3.4 |
| | Females | 146.7 ± 18.8 | 11.9 ± 3.4 |
| Treatment group 3 | Males | 156.7 ± 40.3 | 11.1 ± 3.4 |
| | Females | 149.0 ± 17.4 | 11.6 ± 4.1 |
| Treatment group 4 | Males | 141.7 ± 5.0 | 11.4 ± 3.9 |
| | Females | 134.5 ± 22.6 | 11.0 ± 1.2 |
| Treatment group 5a | Males | 151.5 ± 30.9 | 11.7 ± 2.5 |
| Treatment group 5b | Females | 143.5 ± 10.3 | 11.4 ± 3.0 |
| Treatment group 6a | Males | 145.8 ± 20.0 | 11.5 ± 2.3 |
| Treatment group 6b | Females | 140.0 ± 8.7 | 11.8 ± 2.5 |
| Treatment group 7a | Males | 144.2 ± 22.0 | 11.0 ± 1.9 |
| Treatment group 7b | Females | 140.0 ± 13.4 | 11.0 ± 1.8 |

### Results:

The treatment groups 7a and 7b (administered with gentamycin followed by enzobiotic combination C), wherein the animals were given enzobiotic combination C in animals with gentamycin induced renal damage, exhibited comparable sodium levels to that of the normal control group indicating the sodium levels are maintained by the enzobiotic combination C. The treatment groups 7a and 7b exhibited significant reduction in sodium levels when compared to the animal groups in the treatment group 2 (positive control, administered with enzobiotic combination C alone), animals in the positive control treatment group 3 (positive control, administered with proteolytic enzyme B alone) and animals in the treatment groups 5a and 5b (administered with gentamycin followed by synbiotic A) and also exhibited comparatively decreased sodium levels with respect to the treatment groups 6a and 6b (administered with gentamycin followed by proteotic enzyme B), indicating the efficacy of the enzobiotic combination C. The values as comparable to the positive control group rats suggest significant reduction in sodium levels achieved by the enzobiotic combination C and statistical insignificance as compared to the negative control group (treatment group 4).

### Conclusion:

The results indicate the effectiveness and synergistic or combinative effect of the enzobiotic combination C (comprising synbiotic A and proteolytic enzyme B) in showing significant reduction in sodium levels in gentamycin induced kidney damaged animals vis-à-vis the individual effects of administering synbiotic A or proteolytic enzyme B in gentamycin induced kidney damaged animals.

### Calcium Levels:

### Results:

The calcium levels in the animals of the treatment group 7a and 7b (administered with gentamycin followed by enzobiotic combination C) in gentamycin induced kidney damaged rats were significantly reduced as compared to the animals in the normal control treatment group 1, positive control treatment group 2, positive control treatment group 3, negative control treatment group 4. The calcium levels in the animals of the treatment group 7a and 7b in gentamycin induced kidney damaged rats were significantly reduced as compared to the animals in the treatment groups 5a and 5b and treatment groups 6a and 6b.

### Conclusion:

The results indicate that treatment groups 7a and 7b (administered with enzobiotic C) may prevent hypercalcemia in gentamycin induced kidney disease animals. The results also indicate the synergistic or combinative effect of the enzobiotic combination C in showing significant decrease in calcium levels in gentamycin induced kidney damaged animals vis-à-vis the individual effects of administering synbiotic A or proteolytic enzyme B in gentamycin induced kidney damaged animals.

### (vi) Histopathology

The kidney and caecum of the sacrificed animals were collected, preserved in 10% NBF and the control and treatment groups were subjected to histopathology examination.

### Study Methodology:

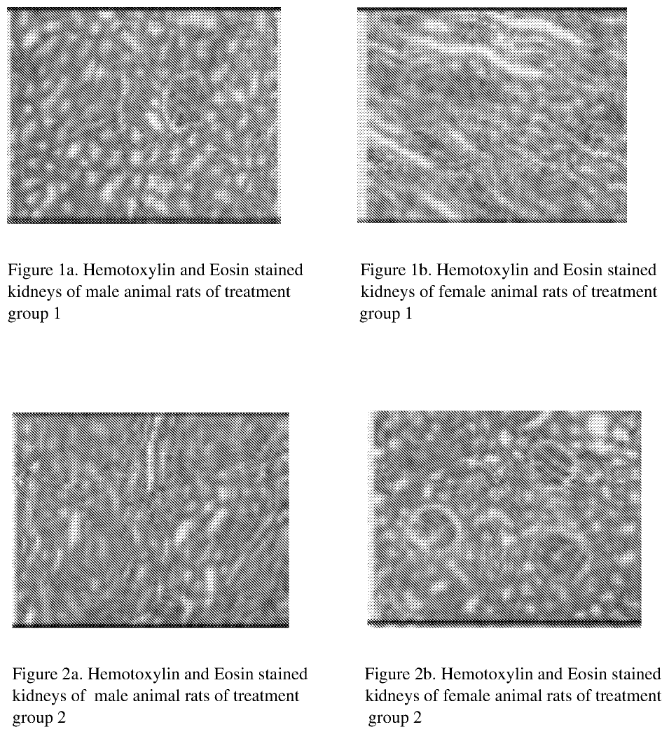

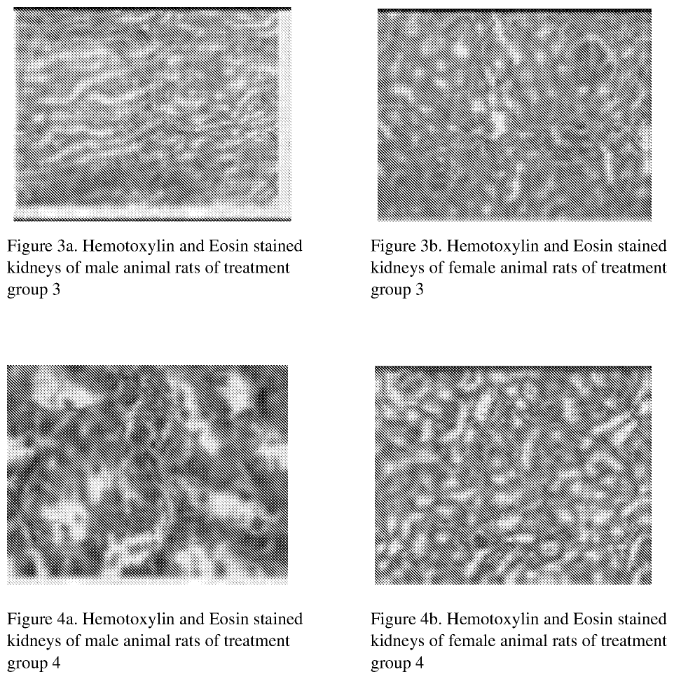

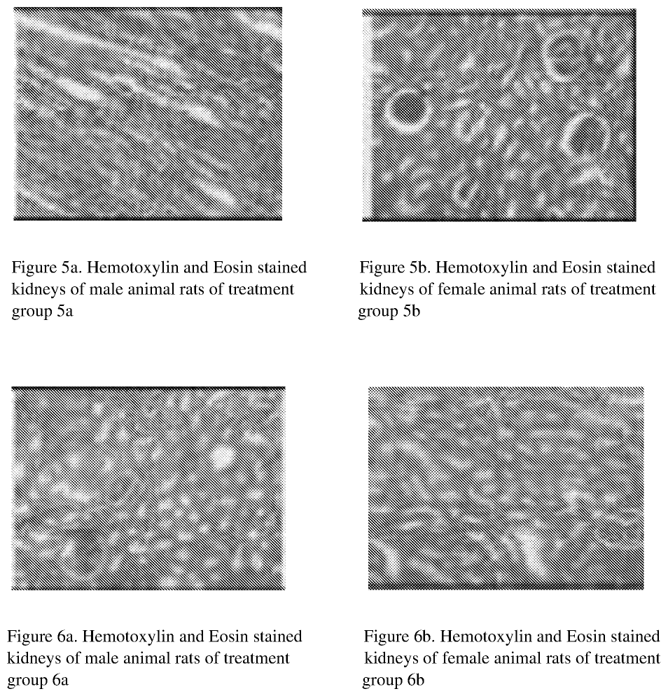

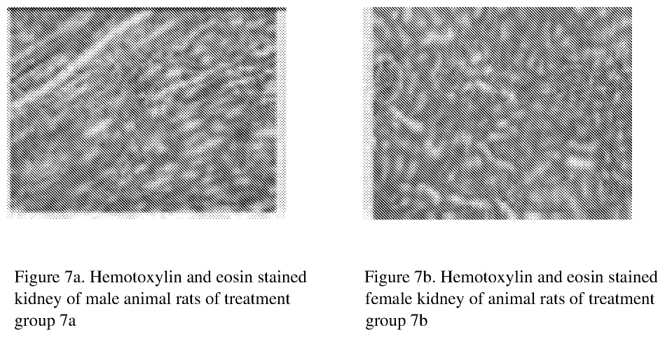

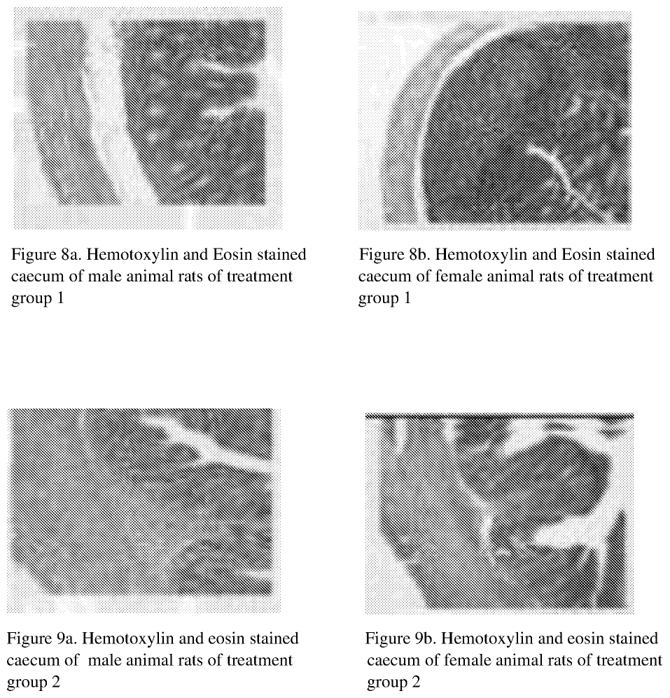

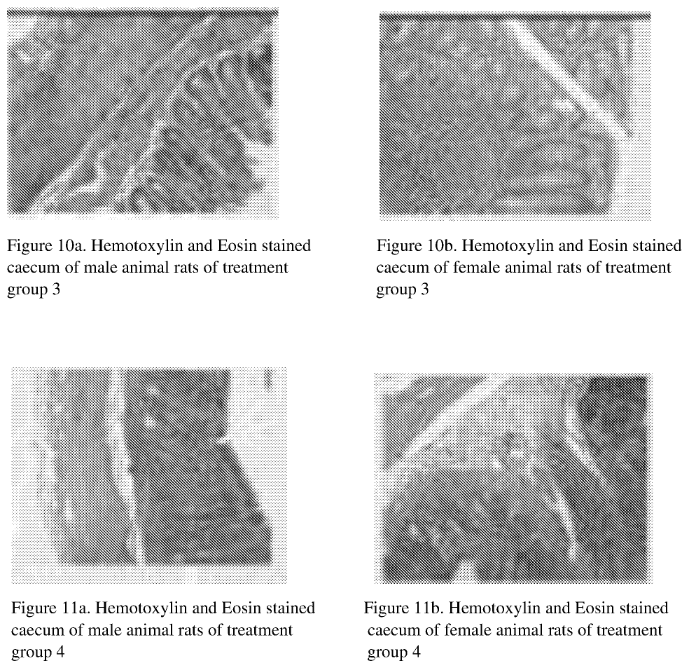

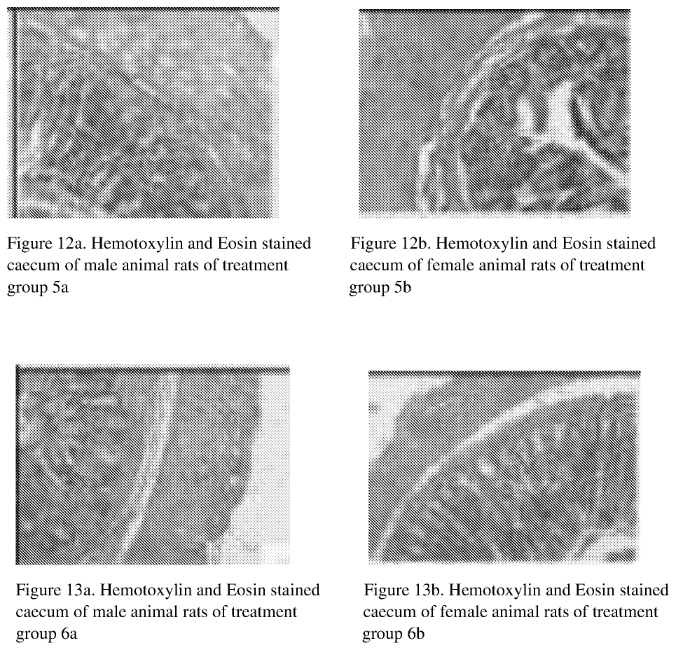

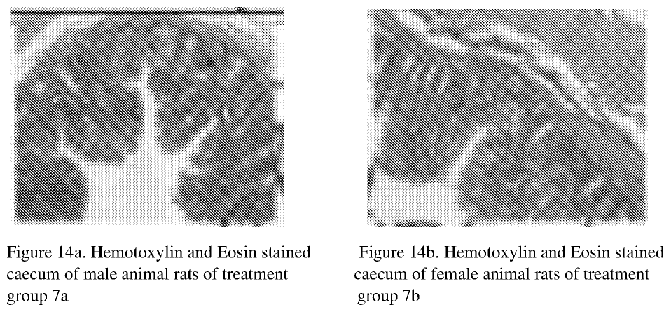

The animal tissues were washed for formalin clearing overnight in running water. Tissues were prepared for staining after serial dilution of alcohol by rehydration and dehydration method. The tissues were embedded in paraffin blocks for sectioning in microtome. The sections were made at a thickness of 4 n suitable for staining. The tissue fixed slides were deparaffinized using xylene and further rehydrated using serially diluted alcohol. Further sections were stained using H & E. The slides were dehydrated by serially diluted alcohol. The microscopical examinations of H & E stained slides were conducted by research microscope at 10× resolution for better visibility and detailed examination. The changes are recorded based on circulatory changes, infiltrative changes and proliferative changes and presented in Table 7 and also in FIGS. 1a to 14b (drawing pages).

TABLE 7
Histopathological examination of kidney and caecum of sacrificed animals

| Treatment group | Kidney Examination | Caecum Examination |
|---|---|---|
| Treatment group 1 | Kidney revealed uniformly spread | The epithelium in mucosa contains |
| | nephrons; intact lining epithelial | enterocytes, microvilli, goblet cells, |
| | distal and proximal tubes were | crypts of Lieberkuhn and transverse |
| | noticed with very rare areas of | folds. Areas of lymphoid aggregates |
| | infiltrations. | in the submucosa. Auerbach's/nerve |
| | | plexus seen in |
| | | serosa. |
| Treatment group 2 | Kidney revealed uniformly spread | The Architecture of the caecul |
| | nephrons, intact lining epithelial | layers was maintained without any |
| | distal and proximal tubes were | distortion. |
| | noticed. | |
| Treatment group 3 | Kidney revealed nephrons, intact | The Architecture of the caecul |
| | collecting ducts leading to renal | layers was maintained without any |
| | papilla. Areas of congestion noted. | distortion. Lymphoid aggregates |
| | | seen. |
| Treatment group 4 | Kidney revealed diffused tubular | The Caecum revealed no alteration |
| | degeneration, especially showing the | of architecture. |
| | higher intensity in the deconvoluted | |
| | tubules. Also noted the shrunk and | |
| | distorted structures of nephrons. | |
| Treatment group 5a | Kidney revealed mild to moderate | Goblet cells activity appeared to be |
| and Treatment | congestions in cortex and medullary | slightly more. |
| group 5b | areas. Lining tubular epithelium | |
| | showing prominent nucleus. | |
| Treatment group 6a | Kidney revealed uniformly spread | Mucosa revealed more goblet cells. |
| and Treatment group | nephrons, intact lining epithelial | Crypts of Lieberkuhn were showing |
| group 6b | distal and proximal tubes were | more proliferative cells and depth of |
| | noticed. | the crypts slightly more. |
| Treatment group 7a | Parenchyma of kidney revealed | Proactive and prominent enterocytes |
| and Treatment group | tubular regeration, evident with | of the villi, proliferative goblet cells |
| group 7b | capillaries around ducts, intact | increased depth of crypts of |
| | cytoplasm and prominent nucleus. | Lieberkuhn. |
| | Nephron revealed active tuft and | |
| | uniform bowman space. | |

### Conclusion:

The animals in the treatment group 1, treatment group 2 and treatment group 3 (the control group and the positive control groups) revealed a normal architectural picture of kidney and caecum with proper epithelial layers and circulatory system in place. The impact of damage of kidney in gentamycin treated rats (in negative control-treatment group 4) revealed distal tubular degeneration and moderate degree of damage in the corticular nephrons indicating nephrotoxicity. While the caecum in gentamycin induced rats (in negative control-treatment group 4), revealed a mild degree of degeneration but not a specific degeneration. In this treatment group 4, the kidneys of both male and female rats showed extensive and diffused distal tubular degeneration. The cortex revealed shrunk nephrons with increased bowman's space.

The kidney and caecum treatment groups 5a and 5b (male and female rats treated with gentamycin followed by synbiotic A) and the treatment groups 6a and 6b (male and female rats treated with gentamycin followed by proteolytic enzyme B) did not show much regenerative lesions like new capillaries, endotheliosis and proper cellular contour with intact cytoplasm; whereas, the kidney and caecum of rats in the treatment groups 7a and 7b (male and female rats treated with gentamycin followed by enzobiotic combination C), revealed tubular regeneration, evident with capillaries around ducts, intact cytoplasm and prominent nucleus and the nephrons revealed active tuft and uniform bowman space.

The histopathology findings revealed no injury or damage in the kidney and caecum of animals treated with the enzobiotic combination C. The histopathological results further indicate the effectiveness and synergistic or combinative effect of the enzobiotic combination C (comprising synbiotic A and proteolytic enzyme B) in showing marked improvement in kidney parenchyma and health of caecum in gentamycin induced kidney damaged animals vis-à-vis the individual effects of administering synbiotic A or proteolytic enzyme B in gentamycin induced kidney damaged animals. From the histopathological results, it can further be concluded that the enzobiotic combination C when administered in rats with kidney disease or damage, show significant nephroprotective effect.

### Example 3

### Preparation of an Enzobiotic Oral Capsule Composition and Clinical Studies for the Enzobiotic Oral Capsule Composition

An enzobiotic oral capsule composition comprising the enzobiotic combination was formulated as below:

TABLE 8
An enzobiotic oral capsule composition

| | Amount in the |
|---|---|
| Components | composition |
| Lactobacillus Acidophilus ATCC 4356 strain | 75 mg to 100 mg |
| Bifidobacterium longum ATCC 15707 strain | 100 mg to 125 mg |
| Streptococcus Thermophilus ATCC 19258 strain | 50 mg to 75 mg |
| Fructooligosaccharide | 100 mg to 125 mg |
| Proteolytic enzyme B - Combination of Bacillus | 150 mg to 200 mg |
| subtilis ATCC 11774 strain whole protease cell with | having a protease |
| bromelain extract obtained from the fruits of | activity of 52,500 |
| Ananus comosus | to 70,000 HUT |
| MCC | q.s |
| Magnesium stearate | q.s. |
| Talc | q.s. |

The processed bulk probiotic microorganisms (Lactobacillus Acidophilus ATCC 4356 strain, Bifidobacterium longum ATCC 15707 strain and Streptococcus thermophilus ATCC 19258 strain) in specified amounts (as provided in Table 8) were combined with specified amounts of the prebiotic component (fructooligosaccharide, in specified amounts as provided in Table 8) to produce a synbiotic A₁. The synbiotic A₁ which was then combined with the proteolytic enzyme powder B (comprising B. subtilis and Ananas comosus) in specified amounts as provided in Table 8. Magnesium stearate (anticaking agent), MCC (filler) and talc (free flowing agent) were added in sufficient amounts (as provided in Table 8) depending upon the flow required to fill into 500 to 550 mg HPMC capsule and the oral capsule was prepared at a RH of 25 to 38% and a temperature varying from 18 to 25° C., according to standard procedures known in the art. The probiotic microorganisms contained in Synbiotic A₁ were obtained from Dupont, United States of America (USA) and the Protease Enzyme powder B was obtained from Deerland Enzymes Inc., USA. Alternately, the protease Enzyme powder B can also be obtained according to process steps provided in Example 1 hereinabove.

### Objective of the Study:

To evaluate the efficacy of the oral capsule comprising the enzobiotic combination of the present invention in CKD stages 3 to 5 and its effectiveness in reducing the generation of p-cresol and indoxyl sulphate and quality of life in pre dialysis patients. The key hypothesis being, the composition of the present invention, when administered can prevent formation of uremic toxins and this early intervention in controlling toxin levels can reduce CKD complications and slow CKD progression and thus can improve the quality of life of CKD patients.

### Study Design:

The study was a prospective, double blinded, randomized, placebo controlled multi-centric interventional study of orally administered enzobiotic composition of the present invention for subjects in stages 3, 4 and 5. There were 40 subjects in the enzobiotic administered group and 40 subjects in the placebo group and the duration of the study conducted was for 90 days. The subjects were aged between 18 and 70 years, wanting to delay dialysis and willing to visit for regular follow-ups.

### Exclusion Criteria:

The following exclusion criteria were applied and the subjects who were excluded: a) pregnant and lactating mothers; b) subjects with autoimmune disease e.g. SLE/Vasculitis; subjects with hepatic impairment (SGOT or SGPT levels >3 times the upper limit); c) patients with diabetic foot infection; d) subjects with uncontrolled cardiovascular events; e) patients who had been prescribed synbiotics and enzymes; f) subjects with any other severe systemic illness and in the opinion of the investigator would be non-compliant with the visit schedule or study procedures.

### (i) Effect on Uremic Toxins in CKD Patients:

### Results:

In the subjects administered with enzobiotic oral capsule of the present invention, the p-cresol levels reduced by 23% showing improvement by 2.35 times, whereas p-cresol levels increased by 27% in the placebo group.

The indoxyl sulphate levels increased by 20% in the placebo group, whereas in subjects administered with enzobiotic oral capsule of the present invention, the indoxyl sulphate levels reduced to 500 μg/ml.

### Conclusion:

The clinical studies indicate the effectiveness, synergistic and combinative effect of the enzobiotic oral capsule composition of the present invention which significantly reduces the p-cresol levels and indoxyl sulphate levels in CKD stages 3, 4 and 5 patients.

### (ii) Effect on Cardiac Performance:

The cardiac performance was evaluated by measuring the combination effect of Heart Rate and Platelet count and its effect was classified as Good, Bad and No response.

### Results:

The subjects administered with enzobiotic oral capsule had 40% of subjects with Good response, whereas in the placebo group there were only 12.5% subjects with Good response. The administration of the enzobiotic oral capsule reduced the p-cresol levels to 23% and this resulted in significant increase in platelet count in such patients and thus proved to be effective to improve cardiac performance, whereas p-cresol levels increased by 27% in the placebo group resulting in poor cardiac performance Conclusion:

The results indicate that in subjects administered with enzobiotic oral capsule of the present invention, the enzobiotic composition proved to be effective in improving cardiac performance and quality of life in CKD stage 3, stage 4 and stage 5 patients.

(iii) Effect on CKD Patients in Subjects Suffering from SARS-CoV-2 or COVID-19 Infection:

The efficacy of the enzobiotic oral capsule in CKD patients in subjects suffering from SARS-CoV-2 or COVID-19 infection was evaluated. In COVID-19 infection, the Hemoglobin carrying RBCs is affected by indoxyl sulfate significantly. If indoxyl sulphate toxin exceeds 2000 μg/ml, the RBC reduces below 4 million to 6 million.

### Results:

The administration of the enzobiotic oral capsule to CKD patients in subjects suffering from SARS-CoV-2 or COVID-19 infection reduced the indoxyl sulphate levels to 500 μg/ml and this resulted in significant increase in RBC count in such patients, proving effective in improved recovery of these patients.

### Conclusion:

The results indicate that the enzobiotic oral capsule of the present invention is effective and ensures better recovery of CKD patients in subjects suffering from SARS-CoV-2 or COVID-19 infection.

### Example 4

### Preparation of the Enzobiotic Sachet Composition

An enzobiotic sachet composition comprising the enzobiotic combination was formulated as below:

TABLE 9
An enzobiotic sachet composition

| | Amount in the |
|---|---|
| Components | composition |
| Lactobacillus Acidophilus ATCC 4356 strain | 400 mg |
| Bifidobacterium longum ATCC 15707 strain | 400 mg |
| Streptococcus Thermophilus ATCC 19258 strain | 100 mg |
| Fructooligosaccharide | 100 mg |
| Proteolytic enzyme - Combination of Bacillus | 50 mg to 200 mg |
| subtilis ATCC 11774 strain comprising bacterial | having a bacterial |
| protease whole cell with bromelain extract obtained | protease activity |
| from the fruits of Ananus comosus | of 25,000 to |
| | 70,000 HUT |
| Maltodextrin and Sucralose | q.s |
| Magnesium stearate | q.s. |
| Talc | q.s. |
| Orange flavour | q.s. |

The processed bulk probiotic microorganisms (Lactobacillus Acidophilus ATCC 4356 strain, Bifidobacterium longum ATCC 15707 strain and Streptococcus Thermophilus ATCC 19258 strain in specified amounts (as provided in Table 9) were combined with specified amounts of the prebiotic component (fructooligosaccharide in specified amounts as provided in Table 9) to produce synbiotic A. The synbiotic A was then combined with the proteolytic enzyme powder (comprising B. subtilis and Ananas comosus) in specified amounts as provided in Table 9. Magnesium stearate (anticaking agent), maltodextrin and sucralose (fillers) were added in sufficient amounts along with talc (free flowing agent) and orange flavour and prepared as a sachet formulation at a RH of 25 to 38% and a temperature varying from 18 to 25° C., according to standard procedures known in the art. The composition was packed using a four layered packaging material (comprising aluminium, paper and polyethylene).

The enzobiotic combination comprised in this enzobiotic sachet composition, for instance, the representative enzobiotic combination C prepared according to the procedure described in Example 1 (wherein the specified amounts of each of the probiotic microorganisms, prebiotic and the proteolytic enzyme in the enzobiotic combination C as provided in Table 1) was tested for animal studies, the results of which are discussed hereinabove in Example 2.

I claim:

1. An enzobiotic therapeutic combination comprising a therapeutically effective amount of:
(i) a synbiotic comprising at least one probiotic and at least one prebiotic; and
(ii) at least one proteolytic enzyme.

2. An enzobiotic therapeutic combination according to claim 1, wherein the combination comprises a therapeutically effective amount of:
(i) a synbiotic comprising at least one probiotic and at least one prebiotic;
(ii) at least one proteolytic enzyme,
wherein, said combination is capable of reducing the concentration of protein bound uremic toxins, p-cresol by 20 to 30% and indoxyl sulphate by 500 to 1500 μg/ml; and
wherein, said combination when administered to a subject in need thereof provides nephroprotective effect.

3. A combination according to claim 1 or claim 2, wherein, said combination is capable of reducing p-cresol concentration by 23% and indoxyl sulphate concentration by 500 μg/ml;
and wherein, said combination when administered to a subject in need thereof provides nephroprotective effect.

4. A combination according to any one of claims 1 to 3, wherein, said combination comprises:
(i) a) a probiotic comprising at least one of Lactobacillus strains, at least one of Bifidobacterium strains and at least one of Streptococcus strains or combinations thereof;
b) a prebiotic comprising at least one oligosaccharide;
(ii) a proteolytic enzyme, wherein the proteolytic enzyme is selected from the group consisting of pepsin, trypsin, chymotrypsin, an enzyme obtained from a bacterial strain or a fungal strain and an enzyme obtained from the fruits of Ananas comosus.

5. A combination according to any one of claims 1 to 4, wherein said Lactobacillus strain is selected from the group consisting of L. acidophilus, L. brevis, L. bulgaricus, L. casei, L. fermentum, L. helviticus, L. plantarum, L. Leichmannii, L. salivarius and L. cellobiosus.

6. A combination according to claim 4 or claim 5, wherein the Lactobacillus strain is Lactobacillus acidophilus ATCC 4356 strain.

7. A combination according to any one of claims 1 to 4, wherein said Bifidobacterium strain is selected from the group consisting of B. bifidum, B. longum and B. infantis.

8. A combination according to claim 4 or claim 7, wherein the Bifidobacterium strain is Bifidobacterium longum ATCC 15707 strain.

9. A combination according to any one of claims 1 to 4, wherein said Streptococcus strain is selected from the group consisting of S. thermophilus, S. diacetilactis, S. cremoris, S. durans and S. faecalis.

10. A combination according to claim 4 or claim 9, wherein the Streptococcus strain is Streptococcus thermophilus ATCC 19258 strain.

11. A combination according to any one of claims 1 to 4, wherein said prebiotic is an oligosaccharide selected from the group consisting of: a fructooligosachharide, inulin, pectic polysaccharide, a mannan, a beta-glucan, a pentosan, an arabinan, a galactan or combinations thereof.

12. A combination according to claim 4 or claim 11, wherein the prebiotic is a fructooligosaccharide.

13. A combination according to any one of claims 1 to 4, wherein the proteolytic enzyme is an enzyme obtained from a bacterial strain, preferably a Bacillus strain in combination with an enzyme obtained from the fruits of Ananas comosus.

14. A combination according to claim 4 or claim 13, wherein the proteolytic enzyme is obtained from Bacillus subtilis ATCC 11774 strain comprising bacterial protease whole cell in combination with bromelain extract obtained from the fruits of Ananas comosus, having a protease activity of 25,000 to 70,000 HUT.

15. A combination according to any one of claims 1 to 14, wherein, said combination comprises:
(i) a synbiotic comprising of a) a probiotic selected from the bacterial strains of Lactobacillus acidophilus ATCC 4356 strain, Bifidobacterium longum ATCC 15707 strain and Streptococcus thermophilus ATCC 19258 strain or combinations thereof;
b) a prebiotic, preferably, a fructooligosaccharide; and
(ii) a proteolytic enzyme obtained from a bacterial strain, Bacillus subtilis ATCC 11774 strain comprising bacterial protease whole cell in combination with bromelain extract obtained from the fruits of Ananas comosus, having a protease activity of 25,000 to 70,000 HUT.

16. A combination according to any one of claims 1 to 15, wherein, said combination comprises:
(i) synbiotic comprising a) 15 to 45 wt % of Lactobacillus acidophilus ATCC 4356 strain, 15 to 45 wt % of Bifidobacterium longum ATCC 15707 strain and 7 to 30 wt % of Streptococcus thermophilus ATCC 19258 strain;
b) 15 to 25 wt % of fructooligosaccharide; and
(ii) 15 to 45 wt % of Bacillus subtilis ATCC 11774 strain comprising bacterial protease whole cell in combination with bromelain extract obtained from the fruits of Ananas comosus, having a protease activity of 25,000 to 70,000 HUT.

17. A combination according to any one of claims 1 to 16, wherein the combination comprises:
(i) a synbiotic comprising a) 5 to 40 billion counts of cells of Lactobacillus acidophilus ATCC 4356 strain, 5 to 30 billion counts of cells of Bifidobacterium longum ATCC 15707 strain and 5 to 35 billion counts of cells of Streptococcus thermophilus ATCC 19258 strain;
b) 100 to 500 mg of fructooligosaccharide; and
(ii) 50 to 200 mg of Bacillus subtilis ATCC 11774 strain comprising bacterial protease whole cell in combination with bromelain extracted from the fruits of Ananas comosus, having a protease activity of 25,000 to 70,000 HUT.

18. A combination according to any one of claims 1 to 17, wherein the combination comprises:
(i) a) 12.5 to 20 billion counts of cells of Lactobacillus acidophilus 4356 strain, 12.5 to 20 billion counts of cells of Bifidobacterium longum ATCC 15707 strain and 5 to 10 billion counts of cells of Streptococcus thermophilus ATCC 19258 strain;
b) 100 to 125 mg of fructooligosaccharide;
(ii) 100 to 200 mg of Bacillus subtilis ATCC 11774 strain comprising bacterial protease whole cell in combination with bromelain extract obtained from the fruits of Ananas comosus having a protease activity of 35,000 to 70,000 HUT.

19. A combination according to any one of claims 1 to 17, wherein the combination comprises:
(i) a) 5 to 10 billion counts of cells of Lactobacillus acidophilus ATCC 4356 strain; 5 to 10 billion counts of cells of Bifidobacterium longum ATCC 15707 strain; 5 to 7.5 billion counts of cells of Streptococcus thermophilus ATCC 19258 strain;
b) 100 mg of fructooligosaccharide;
(ii) 75 to 100 mg of Bacillus subtilis ATCC 11774 strain comprising bacterial protease whole cell in combination with bromelain extract obtained from the fruits of Ananas comosus having a protease activity of 25,000 to 35,000 HUT.

20. A combination according to any one of claims 1 to 17, wherein the combination comprises:
(i) a) 12.5 billion counts of cells of Lactobacillus acidophilus ATCC 4356 strain; 12.5 billion counts of cells of Bifidobacterium longum ATCC 15707 strain; 5 billion counts of cells of Streptococcus thermophilus ATCC 19258 strain;
b) 100 mg of fructooligosaccharide;
(ii) 75 to 150 mg of Bacillus subtilis ATCC strain comprising bacterial protease whole cell in combination with bromelain extract obtained from the fruits of Ananas comosus having a protease activity of 26,250 to 52,500 HUT.

21. A combination according to any one of claims 1 to 16, wherein the combination comprises:
(i) a) 30 to 45 billion counts of cells of Lactobacillus acidophilus ATCC 4356 strain, 30 to 60 billion counts of cells of Bifidobacterium longum ATCC 15707 strain and 15 to 30 billion counts of cells of Streptococcus thermophilus ATCC 19258 strain per daily dose;
b) 100 to 400 mg of fructooligosaccharide per daily dose;
(ii) 151.5 to 303 mg of Bacillus subtilis ATCC 11774 strain comprising bacterial protease whole cell and 140.5 to 300 mg of bromelain extract obtained from the fruits of Ananas comosus per daily dose of the combination.

22. A combination according to any one of claims 1 to 16, wherein the combination comprises:
(i) a) 10 to 15 billion counts of cells of Lactobacillus acidophilus ATCC 4356 strain, 15 to 30 billion counts of cells of Bifidobacterium longum ATCC 15707 strain and 5 to 15 billion counts of cells of Streptococcus thermophilus ATCC 19258 strain per single dose;
b) 100 to 125 mg of fructooligosaccharide per single dose;
(ii) 50.5 to 101 mg of Bacillus subtilis ATCC 11774 strain comprising bacterial protease whole cell and 49.5 to 100 mg of bromelain extract obtained from the fruits of Ananas comosus per single dose of the combination.

23. A combination according to any one of claims 1 to 22, wherein the combination comprises a further therapeutic agent selected from a micronutrient, preferably at least one vitamin selected from the group consisting of Vitamin A, Vitamin C, Vitamin E and Vitamin K and a mineral, preferably zinc.

24. An enzobiotic therapeutic combination comprising a therapeutically effective amount of:
(i) a synbiotic comprising at least one probiotic and at least one prebiotic; and
(ii) at least one proteolytic enzyme for use in the treatment of renal diseases or disorders.

25. A combination according to claim 24, wherein the combination is a therapeutic supplement or a nutritional supplement or a food supplement and the renal disease or disorder is a stage 1, stage 2, stage 3, stage 4 or stage 5 chronic kidney disease, end stage renal disease, chronic kidney disease in cardiovascular patients and chronic kidney disease in subjects suffering from severe acute respiratory syndrome coronavirus 2 (SARS-CoV-2 or COVID-19) infection.

26. An enzobiotic therapeutic composition comprising a therapeutically effective amount of an enzobiotic therapeutic combination according to any one of claims 1 to 25, and a therapeutically acceptable carrier.

27. A composition according to claim 26, wherein the therapeutically acceptable carrier is selected from a filler selected from the group consisting of microcrystalline cellulose, maltodextrin and sucralose, an anticaking agent selected from the group consisting of magnesium stearate, starch or modified starches, a free flowing agent, preferably talc and a flavouring agent, preferably orange flavour and other optional additives.

28. A composition according to claim 26 or claim 27, wherein the composition is formulated in the form of an oral tablet, oral capsule, powder, sachet, liquid syrup, health drink and nutritional bar.

29. An enzobiotic oral capsule according to any one of claims 26 to 28, wherein the oral capsule comprises:
(i) a) 17 to 20 wt % of Lactobacillus acidophilus ATCC 4356 strain; 18 to 22 wt % of Bifidobacterium longum ATCC 15707 strain; 9 to 11 wt % of Streptococcus thermophilus ATCC 19258 strain; and b) 18 to 22 wt % of fructooligosaccharide;
(ii) 30 to 40 wt % of Bacillus subtilis ATCC 11774 strain comprising bacterial protease whole cell in combination with bromelain extract obtained from the fruits of Ananas comosus having a protease activity of 35,000 to 70,000 HUT; and
(iii) filler, preferably microcrystalline cellulose, 1 to 5 wt % of magnesium stearate as an anticaking agent and 1 to 2 wt % of talc as a free flowing agent; wherein, the probiotics, the prebiotic and the proteolytic enzyme formulated along with the filler together comprise 90 to 95 wt % of the composition.

30. An enzobiotic sachet according to any one of claims 26 to 28, wherein the sachet comprises:
(i) a) 26.6 to 35 wt % of Lactobacillus acidophilus ATCC 4356 strain; 30 to 45 wt % of Bifidobacterium longum ATCC 15707 strain; 10 to 13.33 wt % of Streptococcus thermophilus ATCC 19258 strain; and b) 7.5 to 15 wt % of fructooligosaccharide;
(ii) 25 to 45 wt % of Bacillus subtilis ATCC 11774 strain comprising protease whole cell in combination with bromelain extract obtained from the fruits of Ananas omosus having a protease activity of 25,000 to 70,000 HUT;
(iii) filler, preferably maltodextrin and sucralose, 1 to 5 wt % of magnesium stearate as an anticaking agent, 1 to 2 wt % of talc as a free flowing agent and orange flavour as a flavouring agent; wherein, the probiotics, the prebiotic and the proteolytic enzyme along with the filler together comprise 90 to 95 wt % of the composition.

31. A composition according to any one of claims 26 to 28, wherein the composition comprises:
(i) a) 30 to 45 billion counts of cells of Lactobacillus acidophilus ATCC 4356 strain, 30 to 60 billion counts of cells of Bifidobacterium longum ATCC 15707 strain and 15 to 30 billion counts of cells of Streptococcus thermophilus ATCC 19258 strain per daily dose;
b) 100 to 400 mg of fructooligosaccharide per daily dose;
(ii) 151.5 to 303 mg of Bacillus subtilis ATCC 11774 strain comprising bacterial protease whole cell and 140.5 to 300 mg of bromelain extract obtained from the fruits of Ananas comosus per daily dose of the composition.

32. A composition according to any one of claims 26 to 28, wherein the composition comprises:
(i) a) 10 to 15 billion counts of cells of Lactobacillus acidophilus ATCC 4356 strain, 15 to 30 billion counts of cells of Bifidobacterium longum ATCC 15707 strain and 5 to 15 billion counts of cells of Streptococcus thermophilus ATCC 19258 strain per single dose;
b) 100 to 125 mg of fructooligosaccharide per single dose;
(ii) 50.5 to 101 mg of Bacillus subtilis ATCC 11774 strain comprising bacterial protease whole cell and 49.5 to 100 mg of bromelain extract obtained from the fruits of Ananas comosus per single dose of the composition.

33. A composition according to any one of claims 26 to 28, wherein the composition comprises:
(i) a) 12.5 to 20 billion counts of cells of Lactobacillus acidophilus 4356 strain, 12.5 to 20 billion counts of cells of Bifidobacterium longum ATCC 15707 strain and 5 to 10 billion counts of cells of Streptococcus thermophilus ATCC 19258 per single dose;
b) 100 to 125 mg of fructooligosaccharide per single dose;
(ii) 100 to 200 mg of Bacillus subtilis ATCC 11774 strain comprising bacterial protease whole cell and bromelain extract obtained from the fruits of Ananas comosus having a protease activity of 35,000 to 70,000 HUT per single dose of the composition and administered three doses per day.

34. A composition according to any one of claims 26 to 28, wherein the composition comprises:
(i) a) 5 to 10 billion counts of cells of Lactobacillus acidophilus ATCC 4356 strain; 5 to 10 billion counts of cells of Bifidobacterium longum ATCC 15707 strain; 5 to 7.5 billion counts of cells of Streptococcus thermophilus ATCC 19258 strain per single dose;
b) 100 mg of fructooligosaccharide per single dose;
(ii) 75 to 100 mg of Bacillus subtilis ATCC 11774 strain comprising bacterial protease whole cell and bromelain extract obtained from the fruits of Ananas comosus having a protease activity of 25,000 to 35,000 HUT per single dose of the composition and administered three doses per day.

35. A composition according to any one of claims 26 to 28, wherein the composition comprises:
(i) a) 12.5 billion counts of cells of Lactobacillus acidophilus ATCC 4356 strain; 12.5 billion counts of cells of Bifidobacterium longum ATCC 15707 strain; 5 billion counts of cells of Streptococcus thermophilus ATCC 19258 strain per single dose;
b) 100 mg of fructooligosaccharide per single dose;
(ii) 75 to 150 mg of Bacillus subtilis ATCC 11774 strain comprising bacterial protease whole cell and bromelain extract obtained from the fruits of Ananas comosus having a protease activity of 26,250 to 52,500 HUT per single dose of the composition and administered three doses per day.

36. An enzobiotic kit comprising:
(i) a synbiotic comprising at least one probiotic and at least one prebiotic; and
(ii) at least one proteolytic enzyme; wherein the synbiotic administered in combination with the proteolytic enzyme is capable of reducing the concentration of protein bound uremic toxins, p-cresol and indoxyl sulphate and providing nephroprotective effect in a subject more than when administered alone.

37. A method of reducing protein bound uremic toxins, in a subject, comprising administering to a subject in need thereof, a therapeutically effective amount of an enzobiotic therapeutical combination, wherein the said combination comprises a therapeutically effective amount of:
(i) a synbiotic comprising at least one probiotic and at least one prebiotic; and
(ii) at least one proteolytic enzyme.

38. A method of reducing protein bound uremic toxins, in a subject, comprising administering to a subject in need thereof, a therapeutically effective amount of an enzobiotic therapeutic composition, wherein the said composition comprises a therapeutically effective amount of:
(i) a synbiotic comprising at least one probiotic and at least one prebiotic; and
(ii) at least one proteolytic enzyme.

39. A method for treatment of renal diseases or disorders, in a subject, comprising administering to a subject in need thereof, a therapeutically effective amount of an enzobiotic therapeutical combination, wherein the said combination comprises a therapeutically effective amount of:
(i) a synbiotic comprising at least one probiotic and at least one prebiotic; and
(ii) a proteolytic enzyme, wherein, said combination is capable of reducing the concentration of protein bound uremic toxins, p-cresol and indoxyl sulphate; and
wherein, the said combination when administered to a subject in need thereof provides nephroprotective effect.

40. A method for treatment of renal diseases or disorders, in a subject, comprising administering to a subject in need thereof, a therapeutically effective amount of an enzobiotic therapeutical composition, wherein the said composition comprises a therapeutically effective amount of:
(i) a synbiotic comprising at least one probiotic and at least one prebiotic; and
(ii) a proteolytic enzyme, wherein, said composition is capable of reducing the concentration of protein bound uremic toxins, p-cresol and indoxyl sulphate; and
wherein, the said composition when administered to a subject in need thereof provides nephroprotective effect.

41. Use of an enzobiotic therapeutic combination comprising a therapeutically effective amount of:
(i) a synbiotic comprising at least one probiotic and at least one prebiotic; and
(ii) at least one proteolytic enzyme, wherein said combination is capable of reducing the concentration of protein bound uremic toxins, p-cresol and indoxyl sulphate;
and wherein, the said combination when administered to a subject in need thereof provides nephroprotective effect.

42. Use of an enzobiotic therapeutic composition comprising a therapeutically effective amount of:
(i) a synbiotic comprising at least one probiotic and at least one prebiotic; and
(ii) at least one proteolytic enzyme, wherein said composition is capable of reducing the concentration of protein bound uremic toxins, p-cresol and indoxyl sulphate;
and wherein, the said combination when administered to a subject in need thereof provides nephroprotective effect.
